(19) United States
(12) Patent Application Publication
(10) Pub. No.: US 2013/0155992 A1
(43) Pub. Date: Jun. 20, 2013

(54) METHOD AND DEVICE FOR TRANSMITTING AND RECEIVING REFERENCE SIGNALS IN ACCORDANCE WITH MIMO OPERATION MODE

(71) Applicants: Sungjun Yoon, Seoul (KR); Kyoungmin Park, Seoul (KR)

(72) Inventors: Sungjun Yoon, Seoul (KR); Kyoungmin Park, Seoul (KR)

(73) Assignee: Pantech Co., Ltd., Seoul (KR)

(21) Appl. No.: 13/818,469

(22) PCT Filed: Aug. 17, 2011
(86) PCT No.: PCT/KR11/06058

§ 371 Date: Feb. 22, 2013

(30) Foreign Application Priority Data
Aug. 24, 2010 (KR) 10-2010-0082209
Nov. 10, 2010 (KR) 10-2010-0111818

(51) Int. Cl. H04W 72/04

(52) U.S. Cl. CPC H04W 72/04
USPC 370/329

(57) ABSTRACT

The present disclosure relates to a method for transmitting and receiving control information and generating reference signals in accordance with a multiple-input multiple-output (MIMO) operation mode, and a device thereof. A method for receiving control information and generating reference signals in accordance with an MIMO operation mode includes: allowing a user equipment to receive a cyclic shift parameter from a base station; and setting cyclic shift values and OCC values for each layer by using a cyclic shift, an orthogonality allocation rule, and said received cyclic shift parameter, and generating and transmitting reference signals by using said set values. Said cyclic shift is related to the MIMO operation mode of the user equipment and is selected by referring to a parameter transmitted from an upper layer.

### CROSS-REFERENCE TO RELATED APPLICATIONS

This application is the National Stage Entry of International Application No. PCT/KR2011/006058, filed on Aug. 17, 2011, and claims priority from and the benefit of Korean Patent Application Nos. 10-2010-0082209, filed on Aug. 24, 2010 and 10-2010-0111818, filed on Nov. 10, 2010, all of which are hereby incorporated by reference for all purposes as if fully set forth herein.

### BACKGROUND

1. Field

The present invention relates to a wireless communication system, and more particularly, to a method and apparatus for transmitting and receiving control information and generating a reference signal based on an MIMO operation mode. Also, the present invention relates to a method and apparatus for allocating a cyclic shift parameter using sequence and sequence group hopping information in an MIMO environment and generating and transmitting a reference signal therethrough, and a method and apparatus for receiving a reference signal.

2. Discussion of the Background

As communication systems have developed, various wireless terminals have been utilized by consumers, such as companies and individuals.

A current mobile communication system, for example, 3GPP, Long Term Evolution (LTE), LTE-Advanced (LTE-A), and the like, may be a high capacity communication system capable of transmitting and receiving various data such as image data, wireless data, and the like, beyond providing a sound-based service. Accordingly, there is a desire for a technology that transmits high capacity data, which is comparable with a wired communication network. Also, the system is required to include an appropriate error detection scheme that minimizes loss of information and increases transmission efficiency of the system so as to enhance performance of the system.

Also, varied reference signals (RS s) have been utilized in current various communication systems to provide information associated with a communication environment and the like, to a counterpart apparatus through an uplink or a downlink.

For example, in an LTE system, which is one of the mobile communication methods, a User Equipment (hereinafter referred to as a “UE”) transmits an Uplink Demodulation Reference Signal (UL DM-RS) as a reference signal at each slot. Also, the UE transmits, to a base station, a sounding reference signal as a channel estimation reference signal indicating a status of the UE, and transmits a CRS (Cell-specific Reference Signal) corresponding to a reference signal at every subframe to recognize channel information during downlink transmission.

In general, the reference signals may be periodically generated by a reference signal transmitting apparatus, that is, a UE in a case where the reference signal corresponds to an uplink reference signal, and a base station in a case where the reference signal corresponds to a downlink reference signal, and may be transmitted to a reference signal receiving apparatus.

Also, up to the present, the reference signal has been generated based on a scheme that generates a plurality of sequences by changing a phase based on a complex mode using a predetermined Cyclic Shift.

However, there is a desire for expanding the use of a reference signal or a sequence, due to the flexibility of the latest communication systems.

### SUMMARY

Therefore, the present invention has been made in view of the above-mentioned problems, and an aspect of the present invention is to provide a method and apparatus for transmitting and receiving control information and generating a reference signal based on an MIMO operation mode.

Another aspect of the present invention is to provide a technology for transmitting and receiving a cyclic shift parameter so as to generate a reference signal without separately transmitting information associated with an orthogonality.

Another aspect of the present invention is to provide a technology for allocating a cyclic shift parameter that provides an orthogonality so as to generate a reference signal in an MIMO environment.

Another aspect of the present invention is to provide a technology for allocating a cyclic shift parameter so as to generate a reference signal without separately transmitting information associated with an orthogonality.

In accordance with an aspect of the present invention, provided is a method of receiving control information and generating a reference signal based on an MIMO operation mode, the method including: receiving, by a user equipment, a cyclic shift parameter from a base station, and setting a cyclic shift value and an OCC value of each layer using a cyclic shift and orthogonality allocation rule selected by referring to a parameter that is associated with the MIMO operation mode of the user equipment and is transferred from an upper layer and the received cyclic shift parameter, and generating a reference signal using the set values and transmitting the reference signal.

In accordance with another aspect of the present invention, provided is a method of transmitting control information based on an MIMO operation mode, the method including: selecting a cyclic shift and orthogonality allocation rule by referring to a parameter that a base station transfers to a user equipment in an upper layer with respect to an MIMO operation mode of the user equipment, and transmitting, to the user equipment, a cyclic shift parameter determined based on the selected allocation rule.

In accordance with another aspect of the present invention, provided is an apparatus for receiving control information and generating a reference signal based on an MIMO operation mode, the apparatus including: a receiving unit to receive, in a user equipment, control information from a base station, a cyclic shift parameter calculator to calculate a cyclic shift parameter from a control signal received by the receiving unit, a cyclic shift and orthogonality allocation rule selecting unit to select a cyclic shift and orthogonality allocation rule by referring to a parameter that is associated with the MIMO operation mode of the user equipment and is transferred from an upper layer and the cyclic shift parameter, a reference signal generating unit to set a cyclic shift value and an OCC value for each layer using the selected allocation rule and the received cyclic shift parameter, and to generate a reference signal using the set values, and a transmitting unit to transmit the generated reference signal to the base station.

In accordance with another aspect of the present invention, provided is an apparatus for transmitting control information, the apparatus including: a user equipment configuration status determining unit to determine an MIMO environment of a user equipment, a cyclic shift and orthogonality allocation rule selecting unit to select a cyclic shift and orthogonality allocation rule appropriate for the determined MIMO environment by referring to a parameter that a base station transfers to the user equipment in an upper layer with respect to the MIMO environment, a signal generating unit to generate a signal to transmit control information including a cyclic shift parameter determined based on the selected allocation rule to the user equipment, and a transceiving unit to transmit the signal to the user equipment.

### BRIEF DESCRIPTION OF THE DRAWINGS

FIG. 1 is a diagram illustrating a wireless communication system and structures of a subframe and a time slot of transmission data that are applicable to the wireless communication system according to an exemplary embodiment of the present invention.

FIG. 2 is a diagram illustrating a process in which a UE generates a DM-RS sequence in an LTE environment according to an exemplary embodiment of the present invention.

FIG. 3 is a diagram illustrating a process that receives a CS parameter value (CSI) of 3 bits from a base station and calculates a CS/OCC for each layer according to an exemplary embodiment of the present invention.

FIG. 4 is a diagram illustrating a process that generates and transmits a DM-RS using a parameter value that is associated with a sequence and sequence group hopping and is transmitted and received in an upper layer signaling according to an exemplary embodiment of the present invention.

FIG. 5 is a diagram illustrating a process that generates and transmits a DM-RS using a parameter value transmitted and received in an upper layer signaling according to another exemplary embodiment of the present invention.

FIG. 6 is a diagram illustrating a process in which a base station selects an allocation rule based on an MIMO environment or operation mode of a user equipment, and transmits a cyclic shift parameter selected based on selected allocation rule to the user equipment according to an exemplary embodiment of the present invention.

FIG. 7 is a diagram illustrating a process in which a user equipment selects an allocation rule based on a received cyclic shift parameter and an MIMO environment or operation mode, and transmits a demodulation reference signal generated based on the selected allocation rule to a base station according to an exemplary embodiment of the present invention.

FIG. 8 is a diagram illustrating a configuration of an apparatus for transmitting a cyclic shift parameter according to an exemplary embodiment of the present invention.

FIG. 9 is a diagram illustrating a configuration of an apparatus for transmitting a reference signal that satisfies an orthogonality by receiving a cyclic shift parameter according to an exemplary embodiment of the present invention.

FIG. 10 is a diagram illustrating an example of allocating a CS value for each layer of a user equipment according to an exemplary embodiment of the present invention.

FIG. 11 is a diagram illustrating an example of allocating a CS value for each layer of a user equipment according to an exemplary embodiment of the present invention.

FIG. 12 is a diagram illustrating an example of allocating a CS value for each layer of a user equipment when a rank is 3 according to an exemplary embodiment of the present invention.

FIG. 13 is a diagram illustrating a separation by a cyclic shift parameter when a rank is 3 according to an exemplary embodiment of the present invention.

FIG. 14 is a diagram illustrating a process in which a user equipment selects a CS allocation rule linked to a sequence and sequence group hopping scheme and generates a DM-RS sequence according to an exemplary embodiment of the present invention.

FIG. 15 is a diagram illustrating an example of selecting a CS allocation rule for each layer based on a type of a sequence and sequence group hopping scheme according to an exemplary embodiment of the present invention.

FIG. 16 is a diagram illustrating a process in which a base station receives a reference signal from a user equipment according to an exemplary embodiment of the present invention.

FIG. 17 is a diagram illustrating a process in which a user equipment receives a cyclic shift parameter for a first layer from a base station, and generates a reference signal by selecting a cyclic shift allocation rule that enables calculation of cyclic shift parameters to be applied to other layers according to an exemplary embodiment of the present invention.

FIG. 18 is a diagram illustrating a process in which a user equipment receives a cyclic shift parameter for a first layer from a base station, and generates a reference signal by selecting a cyclic shift allocation rule that enables calculation of cyclic shift parameters to be applied to other layers according to another exemplary embodiment of the present invention.

FIG. 19 is a diagram illustrating a configuration of an apparatus for receiving a reference signal generated/transmitted using a sequence and sequence hopping scheme in an MIMO environment according to an exemplary embodiment of the present invention.

FIG. 20 is a diagram illustrating a configuration of an apparatus for transmitting a reference signal using sequence and sequence group hopping information in an MIMO environment according to an exemplary embodiment of the present invention.

### DETAILED DESCRIPTION OF THE ILLUSTRATED EMBODIMENTS

Hereinafter, embodiments of the present invention will be described with reference to the accompanying drawings. In the following description, the same elements will be designated by the same reference numerals although they are shown in different drawings. Further, in the following description of the present invention, a detailed description of known functions and configurations incorporated herein will be omitted when it may make the subject matter of the present invention rather unclear.

In addition, terms, such as first, second, A, B, (a), (b) or the like may be used herein when describing components of the present invention. Each of these terminologies is not used to define an essence, order or sequence of a corresponding component but used merely to distinguish the corresponding component from other component(s). It should be noted that if it is described in the specification that one component is “connected,” “coupled” or “joined” to another component, a third component may be “connected,” “coupled,” and “joined” between the first and second components, although the first component may be directly connected, coupled or joined to the second component.

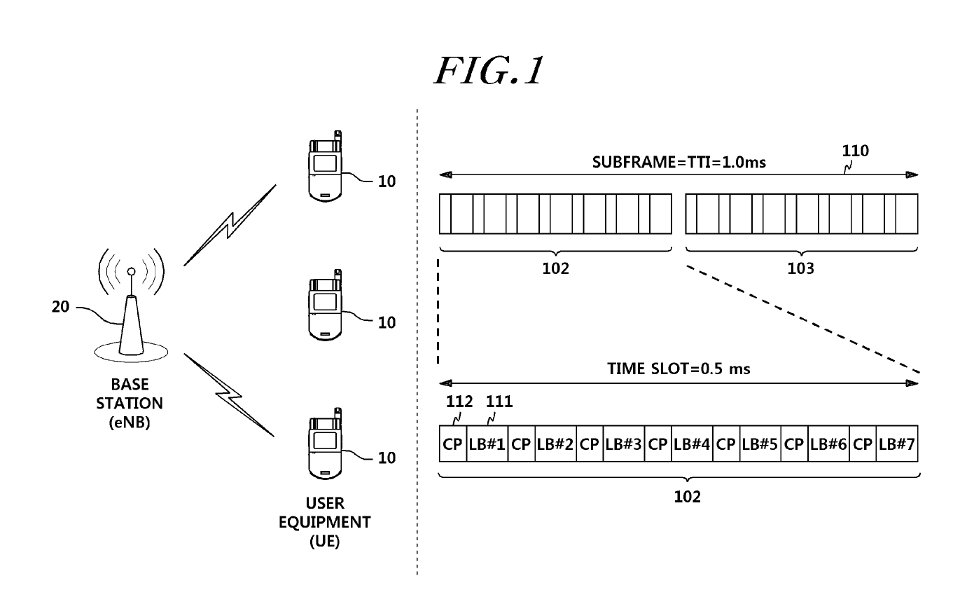

FIG. 1 is a diagram illustrating a wireless communication system and structures of a subframe and a time slot of transmission data that are applicable to the wireless communication system according to an embodiment of the present invention.

The wireless communication system may be widely installed so as to provide various communication services, such as a voice service, packet data, and the like.

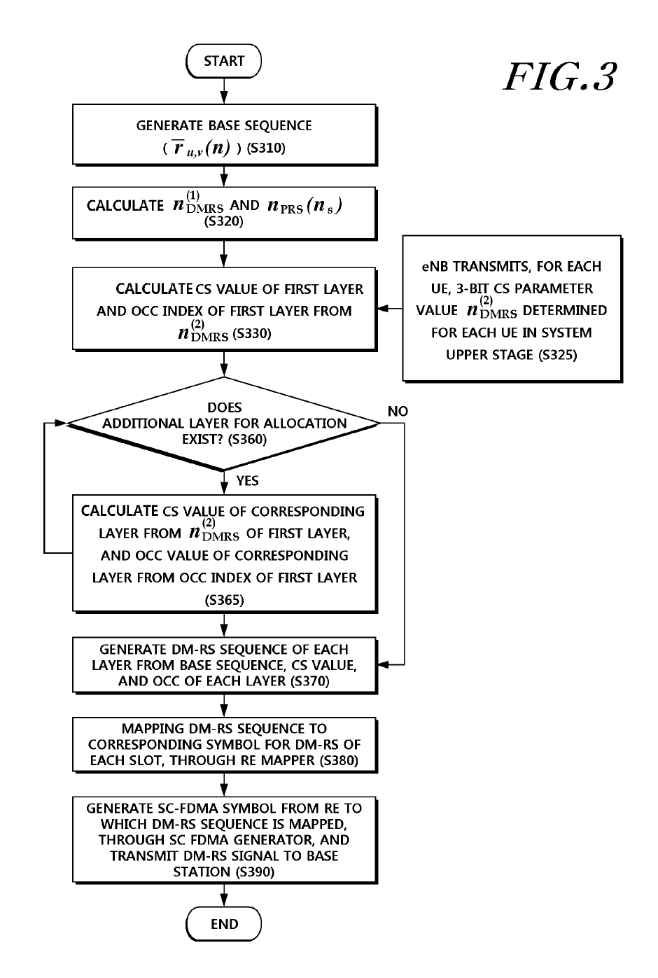

Referring to FIG. 1, the wireless communication system may include a User Equipment (UE) 10 and a Base Station (BS, eNB) 20. A technique of generating a reference signal for expanded channel estimation (Demodulation Reference Signal) according to embodiments of the present invention to be described in below may be applied to the user equipment 10 and the base station 20, which will be described in detail from FIG. 3.

Throughout the specifications, the user equipment 10 may be an inclusive concept indicating a user terminal utilized in wireless communication, including a UE (User Equipment) in WCDMA, LTE, HSPA, and the like, and an MS (Mobile station), a UT (User Terminal), an SS (Subscriber Station), a wireless device, and the like in GSM. Hereinafter, a user equipment, a user terminal, and a UE may be directed to the same meaning.

The base station 20 or a cell may refer to all devices, a function, or a predetermined area where communication with the user equipment 10 is performed, and may also be referred to as a Node-B, an eNB (evolved Node-B), a BTS (Base Transceiver System), an Access Point, a relay node, and the like.

That is, the base station 20 or the cell may be construed as an inclusive concept indicating a portion of an area covered by a BSC (Base Station Controller) in CDMA, a NodeB in WCDMA, and the like, and the concept may include various coverage areas, such as a megacell, a macrocell, a microcell, a picocell, a femtocell, a communication range of a relay node, and the like.

In the specifications, the UE 10 and the base station are used as two inclusive transceiving subjects to embody the technology and technical concepts described in the specifications, and may not be limited to a predetermined term or word.

The wireless communication system may utilize varied multiple access schemes, such as CDMA (Code Division Multiple Access), TDMA (Time Division Multiple Access), FDMA (Frequency Division Multiple Access), OFDMA (Orthogonal Frequency Division Multiple Access), OFDM-FDMA, OFDM-TDMA, OFDM-CDMA, and the like.

Uplink transmission and downlink transmission may be performed based on a TDD (Time Division Duplex) scheme that performs transmission based on different times, or based on an FDD (Frequency Division Duplex) scheme that performs transmission based on different frequencies.

An embodiment of the present invention may be applicable to resource allocation in an asynchronous wireless communication scheme that is advanced through GSM, WCDMA, and HSPA, to be LTE (Long Term Evolution) and LTE-advanced, and may be applicable to resource allocation in a synchronous wireless communication scheme that is advanced through CDMA and CDMA-2000, to be UMB. Embodiments of the present invention may not be limited to a specific wireless communication scheme, and may be applicable to all technical fields to which a technical idea of the present invention is applicable.

The wireless communication system may support an uplink and/or downlink HARQ, and may use a CQI (channel quality indicator) for link adaptation. Also, a multiple access scheme for downlink transmission and a multiple access scheme for uplink transmission may be different from each other. For example, a downlink may use OFDMA (Orthogonal Frequency Division Multiple Access) and an uplink may use SC-FDMA (Single Carrier-Frequency Division Multiple Access).

Layers of a radio interface protocol between a user equipment and a network may be distinguished as a first layer (L1), a second layer (L2), and a third layer (L3), based on three lower layers of a well-known Open System Interconnection (OSI) model in a communication system, and a physical layer of the first layer may provide an information transfer service through use of a physical channel.

A single radio frame or a wireless frame of FIG. 1 may be formed of 10 subframes 110, and a single subframe may include two slots 102 and 103. A basic unit for data transmission may be a subframe, and uplink scheduling or downlink scheduling may be performed based on a subframe unit. A single slot may include a plurality of OFDM symbols in a time domain, and may include at least one subcarrier in a frequency domain, and a single slot may include 7 or 6 OFDM symbols.

For example, when a subframe is formed of two time-slots, each time-slot includes 7 symbols in a time domain and 12 subcarriers in a frequency domain. Although a time-frequency domain defined by a single slot as described in the foregoing may be referred to as a Resource Block (RB), it may not be limited thereto.

In 3GPP LTE system, a transmission time of a frame is divided into a TTI (transmission time interval) having a duration of 1.0 ms. “TTI” and “subframe” may be directed to the same meaning, and a frame having a length of 10 ms may include 10 TTIs.

The diagram 102 illustrates a general structure of a time-slot according to an embodiment of the present invention. As described above, the TTI may be a basic transmission unit, and a single TTI may include two time-slots 102 and 103 of the same length and each time-slot has a duration of 0.5 ms. The time-slot may include seven long blocks (LB) 111 associated with symbols. The LBs may be separated by cyclic prefixes (CP) 112. Although a single TTI or a subframe may include 14 LB symbols, embodiments of the present invention may not be limited to the structure of the frame, the subframe, or the time-slot structure as described in the foregoing. As described in the foregoing, a subframe may include 6 LB symbols for each slot, that is, 12 LB symbols, and the number of symbols may increase or decrease based on a current condition of operation of a network.

In an LTE (Long Term Evolution) communication system, which is one of the wireless communication schemes, an Uplink Demodulation Reference Signal (UL DM-RS) and a sounding reference signal (SRS) are defined for an uplink. Various reference signals are defined for a downlink, that is, a Cell-specific Reference Signal (CRS), a Channel State Information Reference Signal (CSI-RS), an MBSFN (Multicast/Broadcast over Single Frequency Network Reference Signal, a Positioning Reference Signal (PRS), a UE-specific Reference signal which is also referred to as a Downlink Demodulation Reference Signal (DL DM-RS).

That is, the user equipment in the wireless communication system transmits an uplink demodulation signal (UL DMRS or UL DM-RS) at each slot to recognize channel information for demodulation of a data channel during uplink transmission. When a UL DM-RS is associated with a PUSCH (Physical Uplink Shared Channel), a reference signal is transmitted with respect to a single symbol at each slot. In a case of a UL DMRS associated with a PUCCH (Physical Uplink Control Channel), a reference signal is transmitted with respect to up to three symbols at each slot. In this example, a mapped DM-RS sequence may be formed of a Cyclic Shift (CS) and a base sequence r̅_{u,v}(n), and the LTE system may configure a DM-RS sequence for a single layer.

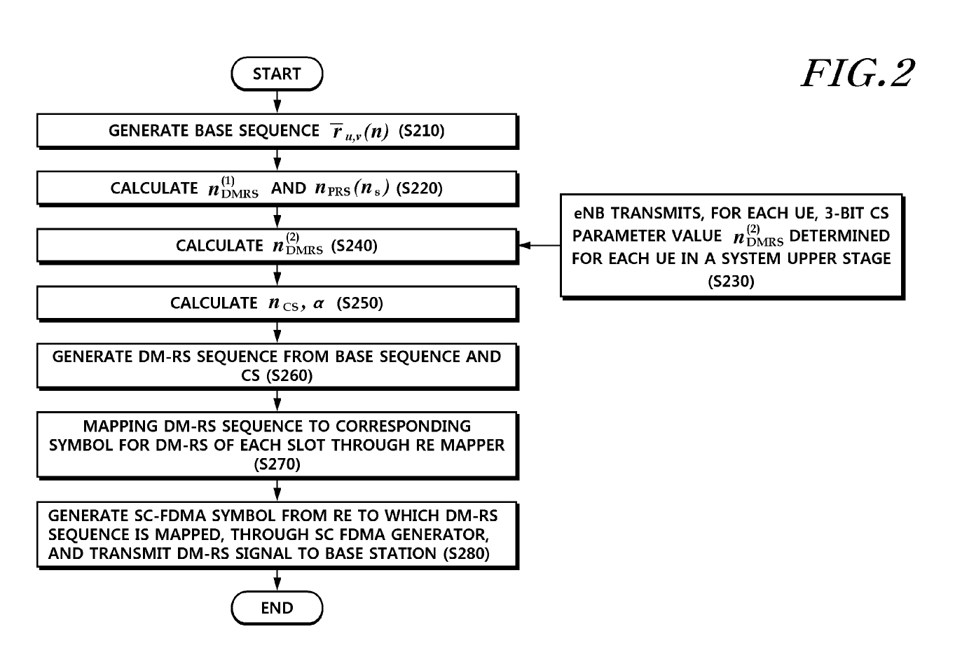

FIG. 2 is a diagram illustrating a process in which a UE generates a DM-RS sequence in an LTE environment.

$${{r}_{u , v}^{( α )} ( n )}_{{\_}_{{↓}_{\begin{matrix}Reference \\ Signal ( RS ) \\ sequence\end{matrix}}}} = {e}^{j {α}_{{\_}_{{↓}_{\begin{matrix}Cyclic \\ Shift ( CS )\end{matrix}}}} n} {{\overline{r}}_{u , v} ( n )}_{{\_}_{\begin{matrix}↓ \\ Base \\ Sequence\end{matrix}}} , \\ \{ \begin{matrix}0 \leq n < {M}_{sc}^{RS} \\ {M}_{sc}^{RS} = {mN}_{sc}^{RB} \\ 1 \leq m \leq {N}_{RB}^{max , UL} \\ {M}_{sc frequency asix for UL DM - RS sequence}^{RS : number of subcarriers allocated i n }\end{matrix} \qquad [ Equation 1 ]$$

Equation 1 shows an example in which a reference signal (RS) sequence is calculated based on α corresponding to a cyclic shift (CS) and a base sequence r̅_{u,v}(n). For a UL DM-RS sequence, a zadoff-chu sequence-based base sequence is generated in step S210. The base sequence may be generated based on a group number u, a base sequence number v in a group, and a length n of a sequence. However, a base sequence of a UL DM-RS that occupies the same base station (cell and the like) and the same frequency bandwidth in a slot time may be identical.

A process of calculating α associated with a cyclic shift (CS) is expressed by Equation 2.

α=2πn_{cs}/12

n_{cs}(n_{DMRS}⁽¹⁾+n_{DMRS}⁽²⁾+n_{PRS}(nₛ))mod12

n_{PRS}(nₛ)=Σᵢ₌₀⁷c(8N_{symb}^{UL}·nₛ+i)·2ⁱ [Equation 2]

To calculate α, n_{cs} may need to calculate n_{DMRS}⁽¹⁾, n_{DMRS}⁽²⁾, and n_{PRS}(nₛ).

n_{DMRS}⁽¹⁾ may be determined based on a cyclic shift parameter value given from an upper layer as illustrated in Table 1. Therefore, n_{DMRS}⁽¹⁾ may be calcualted as shown in Table 1 in step S220.

TABLE 1
n_{DMRS}⁽¹⁾

| cyclicShift | n_{DMRS}⁽¹⁾ |
|---|---|
| 0 | 0 |
| 1 | 2 |
| 2 | 3 |
| 3 | 4 |
| 4 | 6 |
| 5 | 8 |
| 6 | 9 |
| 7 | 10 |

n_{PRS}(n_{S}) may be calculated as illustrated in Equation 2 in step S220, and a pseudo random sequence c(i) may be a cell-specific value.

n_{DMRS}⁽²⁾ may be calculated by a cyclic shift in a DMRS field in the latest DCI format 0 as illustrated in Table 2. It is determined by a cyclic shift parameter value given from an upper layer. As in step S230, the UE (user equipment) may receive, from a base station and the like, a cyclic shift parameter value (or a cyclic shift indicator (CSI)) value of 3 bits that is scheduled and determined in an upper stage. The value of 3 bits may be included in the CS (Cyclic Shift) field of a DCI format 0 as illustrated in Table 2 and may be transmitted. The transmitted value of the cyclic shift field may be mapped as shown in Table 2, and RS may be calculated in steps S230 and S240.

TABLE 2
n_{DMRS}⁽²⁾

| cyclicShift in DCI format 0 | n_{DMRS}⁽²⁾ |
|---|---|
| 000 | 0 |
| 001 | 6 |
| 010 | 3 |
| 011 | 4 |
| 100 | 2 |
| 101 | 8 |
| 110 | 10 |
| 111 | 9 |

Hereinafter, in step S250, n_{cs} and α may be calculated based on the values calculated in step S220 through S240. n_{DM RS}⁽¹⁾ and n_{PRS}(nₛ), which are parameters in n_{cs} to calculate a value of α, may vary based on each base station (cell and the like) and a slot time. However, the parameters may be constant in the same base station (cell and the like) and the same slot time. Therefore, a parameter that actually changes a value of n_{cs} is n_{DMRS}⁽²⁾. That is, the parameter that is scheduled for each UE in an upper stage and transmitted through a base station and the like is n_{DMRS}⁽²⁾, and corresponding to the CS (Cyclic Shift) value of the UL DM-RS may be changed based on a value of n_{DMRS}⁽²⁾.

A DM-RS sequence may be generated based on the base sequence of step S210 and α (cyclic shift value (CS)) of step S250 using Equation 1 in step S260.

The DM-RS sequence generated based on Equations 1 and 2 may be mapped to a corresponding symbol of each slot, and mapping is performed by a resource element mapper in step S270. In a case of a DM-RS associated with a PUSCH, when a normal CP (Cyclic Prefix) is used, the symbol corresponds to the fourth symbol among the seven symbols in each slot, and when an extended CP is used, the symbol corresponds to the third symbol among the symbols of each slot. In the case of a DM-RS associated with a PUCCH, when the corresponding symbol corresponds to up to three symbols in each slot, and a number of corresponding symbols may vary based on a type of a CP and a format of a PUCCH as illustrated in Table 3.

TABLE 3
A location of a symbol in a slot based on
a type of a CP and a format of a PUCCH

location of symbol in slot

| PUCCH format | Normal CP | Extended CP |
|---|---|---|
| 1, 1a, 1b | 2, 3, 4 | 2, 3 |
| 2 | 1, 5 | 3 |
| 2a, 2b | 1, 5 | N/A |

When mapping is completed, an SC-FDMA symbol is generated, through an SC FDMA generator, from a Resource Element (RE) to which the DM-RS sequence is mapped, and a DM-RS signal is transmitted to a base station in step S280.

A next generation communication technology such as an LTE-A (Long Term Evolution-Advanced) system that is currently being discussed, may support up to 4 antennas, and DM-RS sequence mapping that is distinguished for up to 4 layers may be required. Accordingly, an orthogonality may be maintained using a different CS value in a base sequence.

Also, to secure an orthogonality between layers in an SU-MIMO (Single-User Multiple Input Multiple Output) and an MU-MIMO (Multiple-User Multiple Input Multiple Output), or to distinguish a plurality of user equipments in the MU-MIMO, a method of adding an OCC (Orthogonal Cover Code) based on a slot unit has been proposed.

The OCC may be formed as illustrated in Table 4.

TABLE 4
Composition of OCC

| n_{occ} | OCC |
|---|---|
| 0 | {+1, +1} |
| 1 | {+1, −1} |

In a case where a single layer is used, like in a conventional LTE, a CS value that is scheduled and determined in an upper stage is signaled to a UE (user equipment) as a value of 3 bits through a base station (eNB and the like). However, in a system such as LTE-A, a CS value and an OCC may need to be provided so that many layers and user equipments have an orthogonality with respect to each other. For example, when up to four layers are used, an orthogonality may need to be secured for up to four layers by applying a CS and an OCC.

A mapping rule used in the present specifications may indicate a rule that enables a plurality of pieces of information to be obtained using one or two pieces of information, and the rule may be configured as a form of a mathematical equation or may be configured as a form of a table. A user equipment and a base station may store the mapping rule in an internal storage device and may refer to the mapping rule. Also, the mapping rule may be one of a plurality of rules, and the mapping rule may be selected by agreement in advance between the user equipment and the base station or by exchanging predetermined information to determine which of the plurality of mapping rules is to be selected.

FIG. 3 is a diagram illustrating a process that receives n_{DMRS}⁽²⁾ corresponding to a CS parameter value (CSI) of 3 bits from a base station and calculates a CS/OCC for each layer. A few operations in FIG. 3 have already been described in FIG. 2 and thus, detailed descriptions thereof will be omitted.

That is, the process includes receiving n_{DMRS}⁽²⁾ corresponding to a CS parameter value (Cyclic Shift parameter or index value, CSI) of 3 bits from a base station in step S325, determining or calculating a CS value and an OCC value (OCC index) for a first layer using the received value and a predetermined rule or table value in step S330, and determining or calculating a CS value and an OCC value for each layer also based on a predetermined rule or table value in step S365. For example, a CS value for each layer is formed by adding an offset value to the CS value determined for the first layer, and an OCC value for each layer is determined based on an OCC mapping rule that takes into consideration the OCC value for the first layer and each MIMO environment (SU-MIMO or MU-MIMO) or an MIMO operation mode. Also, a CS value and an OCC value for each layer may be expressed by a single table based on an offset value to be added to the CS value and an OCC mapping rule. That is, the corresponding value may be calculated based on a mapping rule or may be selected from table values obtained by applying a mapping rule to each D n_{DMRS}⁽²⁾. This may be variously embodied based on an embodying process.

In this example, there may be three appropriate OCC mapping rules based on each MIMO environment or operation mode. One of the three OCC mapping rules is a mapping rule that takes into consideration the application of an OCC when a rank is 2 in an SU-MIMO. Another OCC mapping rule is an OCC mapping rule appropriate for a case of ranks 3 and 4 in an SU-MIMO and a case of ranks 1 and 2 in an MU-MIMO. A remaining OCC mapping rule is an OCC mapping rule appropriate for a case of transmission of ranks 1, 2, 3, and 4 in an MU-MIMO.

However, in a case where the OCC mapping rule is configured based on each MIMO environment or operation mode, that is, in a case where at least two mapping rules, such as an OCC mapping rule appropriate for an SU-MIMO and an OCC mapping rule appropriate for an MU-MIMO, are configured, when the OCC mapping rule is linked with the CS parameter value (CSI value) n_{DMRS}⁽²⁾, a number of CS parameter values (CSI values) that are allocable to each UE may be decreased. In particular, when an OCC mapping rule that takes into consideration applying of an OCC in a rank 2 in an SU-MIMO is applied to 2 CS parameter values from among a total of 8 allocable CS parameter values (CSI values), an OCC mapping rule appropriate for ranks 3 and 4 in an SU-MIMO and ranks 1 and 2 in an MU-MIMO is applied to another 2 CS parameter values, and an OCC mapping rule appropriate for transmission of ranks 1, 2, 3, and 4 of an MU-MIMO is applied to remaining 4 CS parameter values, a number of CS parameter values (CSI values) allocable to a corresponding UE in each MIMO environment may be reduced down to 2 from 8, which may cause a collision problem during PHICH (Physical Hybrid Indication Channel) resource allocation.

Accordingly, an embodiment of the present invention minimizes a limitation in allocation of a CS parameter value (CSI value) of each layer by using a different OCC mapping rule based on an MIMO environment, and allocates a different Cyclic Shift (CS) value and a different OCC (Orthogonal Cover Code) based on the MIMO environment or operation mode when a Cyclic Shift (CS) value and an OCC (Orthogonal Cover Code) value of each layer of an Uplink (UL) Demodulation Reference Signal (DM-RS) are allocated. To achieve the above, an RRC (Radio Resource Control) parameter value associated with a sequence and a sequence group hopping may be used, or an OCC mapping rule may be changed using a predetermined RRC parameter value. Also, it may be changed based on an OCC change request value transmitted by an apparatus for receiving a cyclic shift parameter. The RRC parameter may be an embodiment of a parameter transmitted and received in an upper layer signaling process, and the following descriptions will be provided based on the RRC parameter. However, embodiments of the present invention may not be limited to the RRC parameter, and may include a value that may be determined or estimated in a process that performs the upper layer signaling.

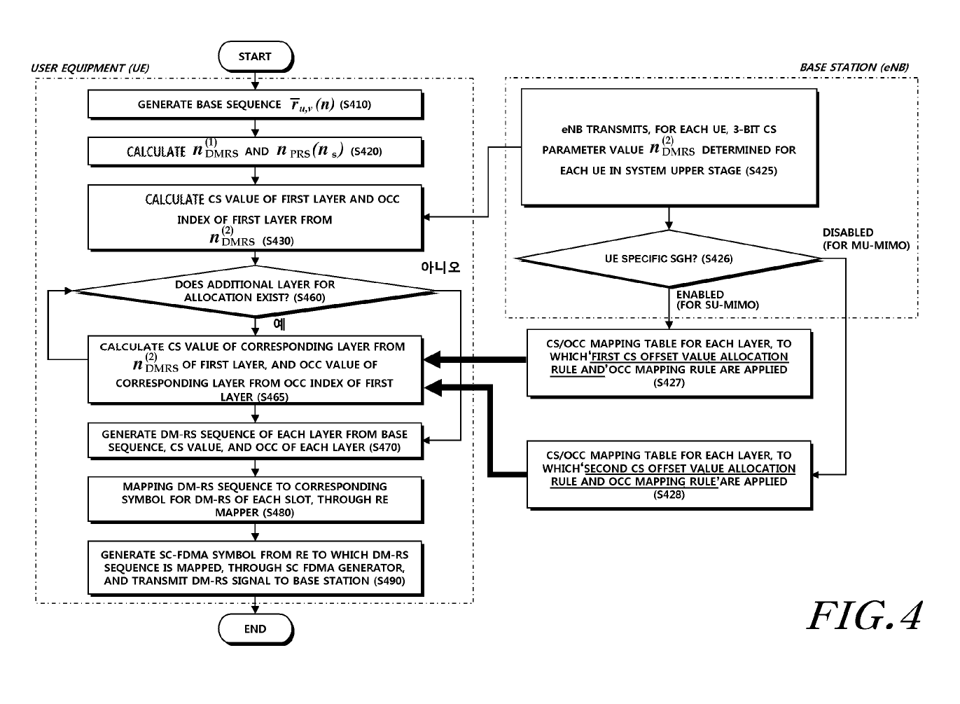

FIG. 4 is a diagram illustrating a process that generates and transmits a DM-RS using a parameter value that is associated with a sequence and sequence group hopping and is transmitted and received in an upper layer signaling according to an embodiment of the present invention.

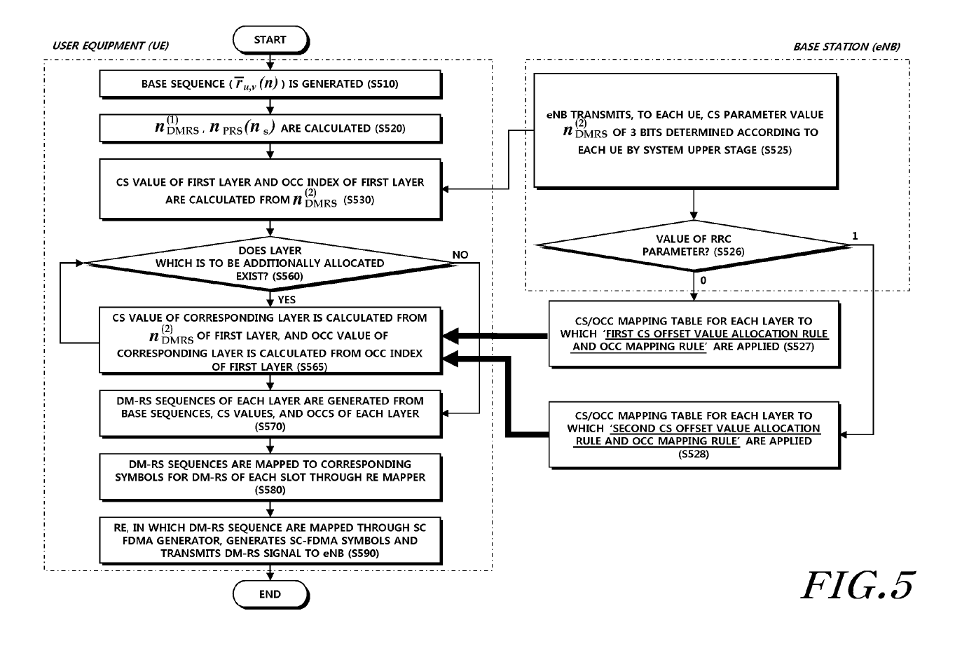

FIG. 5 is a diagram illustrating a process that generates and transmits a DM-RS using a parameter value transmitted and received in an upper layer signaling according to another embodiment of the present invention.

Both processes of FIGS. 4 and 5 calculate a CS value and an OCC value of a predetermined layer (for example, a first layer) by receiving a CS parameter value (CS value) n_{DMRS}⁽²⁾, and may calculate a CS value and an OCC value for each layer using a value calculated from n_{DMRS}⁽²⁾.

That is, n_{DMRS}⁽²⁾ corresponding to the CS parameter value (CSI value) is calculated by a cyclic shift in a DMRS field in the latest DCI format 0 as illustrated in Table 2. It is determined by a cyclic shift parameter value given from an upper layer. As in steps S425 and S525, a UE (user equipment) receives, from a base station and the like, a cyclic shift parameter of 3 bits that is scheduled and determined in an upper stage, and the value of 3 bits may be included in a CS (Cyclic Shift) filed of a DCI format 0 for transmission as described in the embodiment of table 2. The transmitted value of the cyclic shift field may be mapped as shown in Table 2, and n_{DMRS}⁽²⁾ may be calculated in steps S430 and S530.

n_{cs} and α are calculated based on the calculated N_{DMRS}⁽²⁾. n_{DMRS}⁽¹⁾ and n_{PRS}(nₛ), which are parameters in n_{cs} to calculate a value of α, may vary based on each base station (cell and the like) and slot time. However, the parameters may be constant in the same base station (cell and the like) and the same slot time. Therefore, a parameter that actually changes a value of n_{cs} is n_{DMRS}⁽²⁾. That is, the parameter that is scheduled for each UE in an upper stage and transmitted through a base station and the like is n_{DMRS}⁽²⁾, and α corresponding to the CS (Cyclic Shift) value of the UL DM-RS may be changed based on a value of n_{DMRS}⁽²⁾.

That is, the user equipment (UE) calculates a CS α value of a first layer (1st layer) based on the CS parameter value n_{DMRS}⁽²⁾ that is scheduled and determined in a system upper stage and transmitted from a base station (eNB) by being included in the DCI format 0. Also, the UE calculates an OCC index n_{DMRS}^{OCC} of the first layer (1st layer) based on a CSI-OCC linkage rule or table previously determined based on the transmitted cyclic shift (CS) parameter value n_{DMRS}⁽²⁾. Here, an example of the previously determined CSI-OCC linkage rule or table is as follows.

TABLE 5
CSI-OCC linkage rule or table

| CS field value in uplink- | CS value of 1st layer | OCC value of 1st layer |
|---|---|---|
| related DCI format | (CS Layer0) | (OCC Layer0) |
| 000 | 0 | 0 |
| 001 | 6 | 1 |
| 010 | 3 | 1 |
| 011 | 4 | 0 |
| 100 | 2 | 0 |
| 101 | 8 | 1 |
| 110 | 10 | 1 |
| 111 | 9 | 0 |

In a case of Table 5, for example, when the transmitted n_{DMRS}⁽²⁾ value, that is, the CSI value of 3 bits in Table 5 corresponds to 000, 001, 100, and 111 or corresponding CS values corresponds to 0, 4, 2, and 9, n_{DMRS}^{OCC} may be implicitly and automatically calculated to be 0. Conversely, when the transmitted n_{DMRS}⁽²⁾ value, that is, the CSI value of 3 bits in Table 5 corresponds to 001, 010, 101, and 110 or corresponding CS values corresponds to 6, 3, 8, and 10, n_{DMRS}^{OCC} may be implicitly and automatically calculated to be 1. That is, the UE may implicitly calculate a value of n_{DMRS}^{OCC} based on n_{DMRS}⁽²⁾. In this exapmle, when n_{DMRS}^{OCC} corresponds to 0, it indicates OCC {+1, +1}, and when n_{DMRS}^{OCC} corresponds to 1, it indicates OCC {+1, −1}. However, a mathematical expression and value of a parameter that expresses an OCC index may not be limited within a scope where a meaning and content is not changed, and the mathematical expression and value may be variously modified during an embodiment process.

Subsequently, the user equipment (UE) determines whether an additional layer for allocation or a layer to be used exists in addition to the first layer (1st layer or Layer-0). When an additional layer exists, the UE may calculate a CS value of the corresponding layer from a CS parameter value n_{MMTS}⁽²⁾ of the first layer, and may calculate an OCC index of the corresponding layer from an OCC index n_{DMRS}^{OCC} of the first layer.

Here, a CS allocation rule (CS allocation method) that calculates the CS value of the corresponding layer from the CS parameter value n_{DMRS}⁽²⁾ of the first layer may perform allocation by adding an offset value to the CS value for the first layer (1st layer or Layer-0). Examples thereof are as shown in Equation 3 and Equation 4.

n_{DMRS}⁽²⁾: CS parameter of first layer, n_{DMRS}⁽²⁾ ∈ {0,6,3,4,2,8,10,9} [Equation 3]
1) In a case of Rank 2

{n_{DMRS}⁽²⁾ of first layer, n_{DMRS}⁽²⁾ of second layer}={n_{DMRS}⁽²⁾, (n_{DMRS}⁽²⁾+6)mod12}
2) In a case of Rank 3

{n_{DMRS}⁽²⁾ of first layer, n_{DMRS}⁽²⁾ of second layer, n_{DMRS}⁽²⁾ of third layer}={n_{DMRS}⁽²⁾, (n_{DMRS}⁽²⁾+6)mod12, (n_{DMRS}⁽²⁾+3)mod12}
3) In a case of Rank 4

{n_{DMRS}⁽²⁾ of first layer, n_{DMRS}⁽²⁾ of second layer, n_{DMTS}⁽²⁾ of third layer, n_{DMRS}⁽²⁾ of fourth layer}={n_{DMRS}⁽²⁾, (n_{DMRS}⁽²⁾+6)mod12, (n_{DMRS}⁽²⁾+3)mod12, (n_{DMRS}⁽²⁾+9)mod12} [Equation 4]

n_{DMRS}⁽²⁾: CS parameter of first layer, n_{DMRS}⁽²⁾ ∈ {0, 6, 3, 4, 2, 8, 10, 9}
1) In a case of Rank 2

{n_{DMRS}⁽²⁾ of first layer, n_{DMRS}⁽²⁾ of second layer}={n_{DMRS}⁽²⁾, (n_{DMRS}⁽²⁾+6)mod12}
2) In a case of Rank 3
   {n_{DMRS}⁽²⁾ of first layer, n_{DMRS}⁽²⁾ of second layer, n_{DMRS}⁽²⁾ of third layer}={n_{DMRS}⁽²⁾, (n_{DMRS}⁽²⁾3)mod12, (n_{DMRS}⁽²⁾6)mod12}
3) In a case of Rank 4

{n_{DMRS}⁽²⁾ of first layer, n_{DMRS}⁽²⁾ of second layer, n_{DMRS}⁽²⁾ of third layer, n_{DMRS}⁽²⁾ of fourth layer}={n_{DMRS}⁽²⁾, (n_{DMRS}⁽²⁾+3)mod12, (n_{DMRS}⁽²⁾+6)mod12, (n_{DMRS}⁽²⁾+9)mod12}

Also, an OCC allocation rule that calculates the OCC index of the corresponding layer from the OCC index n_{DMRS}^{OCC} of the first layer considers a total number of layers, and provides a maximum orthogonality between layers when OCC values allocated to respective layers are associated with predetermined set CS values, so as to reduce inter-layer interference. Equation 5 is an example of an OCC allocation rule that provides a maximum possible orthogonality when an OCC index allocated to each layer is linked with a CS allocation method defined by Equation 3, based on a number of layers. Also, Equation 6 is an example of an OCC allocation rule that provides a maximum possible orthogonality when an OCC index allocated to each layer is associated with a CS allocation method defined by Equation 4, based on a number of layers.

n_{DMRS}^{OCC}: OCC index of first layer, n_{DMRS}^{OCC}=0→[+1, +1], n_{DMRS}^{OCC}=1→[+1, −1] [Equation 5]
1) In a case of Rank 2

{n_{DMRS}^{OCC} of first layer, n_{DMRS}^{OCC} of second layer}={n_{DMRS}^{OCC}, n_{DMRS}^{OCC}}
2) In a case of Rank 3

{n_{DMRS}^{OCC} of first layer, n_{DMRS}^{OCC} of second layer, n_{DMRS}^{OCC} of third layer}={n_{DMRS}^{OCC}, n_{DMRS}^{OCC}, 1−n_{DMRS}^{OCC}}
3) In a case of Rank 4

{n_{DMRS}^{OCC} of first layer, n_{DMRS}^{OCC} of of second layer, n_{DMRS}^{OCC} of third layer, n_{DMRS}^{OCC} of fourth layer}={n_{DMRS}^{OCC} , n_{DMRS}^{OCC},1−n_{DMRS}^{OCC}} [Equation 6]

n_{DMRS}^{OCC}: OCC index of first layer, n_{DMRS}^{OCC}=0→[+1, +1], n_{DMRS}^{OCC}=1→[+1, −1]
1) In a case of Rank 2
   {n_{DMRS}^{OCC} of first layer, n_{DMRS}^{OCC} of second layer}={n_{DMRS}^{OCC}, 1−n_{DMRS}^{OCC}}
2) In a case of Rank 3

{n_{DMRS}^{OCC} of first layer, n_{DMRS}^{OCC} of second layer, n_{DMRS}^{OCC} of third layer}={n_{DMRS}^{OCC}, 1−n_{DMRS}^{OCC}, n_{DMRS}^{OCC}}
3) In a case of Rank 4

{n_{DMRS}^{OCC} of first layer, n_{DMRS}^{OCC} of second layer, n_{DMRS}^{OCC} of third layer, n_{DMRS}^{OCC} of fourth layer}={n_{DMRS}^{OCC}, 1−n_{DMRS}^{OCC}, 1−n_{DMRS}^{OCC}}

Equation 5 is an OCC mapping rule appropriate for transmissions of ranks 3 and 4 of an SU-MIMO and ranks 1 and 2 of an MU-MIMO in each MIMO environment or operation mode, and Equation 6 is an OCC mapping rule that takes into consideration the application of an OCC to transmissions of ranks 3 and 4 of an SU-MIMO and transmission of a rank 2 of the SU-MIMO.

In this example, when transmissions of ranks 3 and 4 of the MU-MIMO is also taken into consideration, an OCC mapping rule such as Equation 7 may be appropriate. The OCC mapping rule expressed by Equation 7 corresponds to a mapping rule that has different OCC index values for two UEs in an MU-MIMO but has an OCC index value identical to an OCC index value for the first layer with respect to all layers of each UE.

n_{DMRS}^{OCC}: OCC index of first layer, n_{DMRS}^{OCC}=0→[+1, +1], n_{DMRS}^{OCC}=1→[+1, −1]
1) In a case of Rank 2

{n_{DMRS}^{OCC} of first layer, n_{DMRS}^{OCC} of second layer}={n_{DMRS}^{OCC}, n_{DMRS}^{OCC}}
2) In a case of Rank 3

{n_{DMRS}^{OCC} of first layer, n_{DMRS}^{OCC} of second layer, n_{DMRS}^{OCC} of third layer}={n_{DMRS}^{OCC}, n_{DMRS}^{OCC}, n_{DMRS}^{OCC}}
2) In a case of Rank 4

{n_{DMRS}^{OCC} of first layer, n_{DMRS}^{OCC} of second layer, n_{DMRS}^{OCC} of third layer, n_{DMRS}^{OCC} of fourth layer}={n_{DMRS}^{OCC}, n_{DMRS}^{OCC}, n_{DMRS}^{OCC}, n_{DMRS}^{OCC}}

Hereinafter, FIGS. 4 and 5 will be described in detail based on Table 5 and Equations 3, 4, 5, 6, and 7.

As described above, embodiments of FIGS. 4 and 5 minimize a limitation in allocation of a CS parameter value (CSI value) of each layer by using a different OCC mapping rule based on an MIMO environment or operation mode, and allocate a different Cyclic Shift (CS) value and a different OCC (Orthogonal Cover Code) based on the MIMO environment or operation mode when a Cyclic Shift (CS) value and an OCC (Orthogonal Cover Code) value of each layer of an uplink demodulation reference signal are allocated.

To achieve the above, an RRC (Radio Resource Control) parameter value associated with a sequence and a sequence group hopping may be used as illustrated in FIG. 4, or an OCC mapping rule may be changed using a predetermined RRC parameter value as illustrated in FIG. 5. The RRC parameter may be an embodiment of a parameter transmitted and received in an upper layer signaling process, and the following descriptions will be provided based on the RRC parameter. However, embodiments of the present invention may not be limited to the RRC parameter, and may include a value that may be determined or estimated in a process that performs the upper layer signaling.

FIG. 4 is a diagram illustrating a process that generates and transmits a DM-RS using a parameter value that is associated with a sequence and sequence group hopping and is transmitted and received in an upper layer signaling according to an embodiment of the present invention.

The process of FIG. 4 may change an OCC mapping rule based on an indication value associated with a UE-specific SGH associated with a sequence group hopping transferred from an upper stage through an RRC and the like. When the UE-specific SGH is enabled, a CS/OCC mapping table for each layer is configured by applying a ‘first CS offset value allocation rule and OCC mapping rule’ in step S427, so that an OCC mapping rule is applied based on an SU-MIMO environment or an MU-MIMO environment having an equal bandwidth resource allocation. In this example, the CS offset value allocation rule may be configured in accordance with one of the schemes expressed in Equation 3 and Equation 4, and the OCC mapping rule may be configured in accordance with one of the schemes expressed in Equation 5 and Equation 6. In this example, an example of the CS/OCC mapping table for each layer configured by applying the ‘first CS offset value allocation rule and OCC mapping rule’ is as shown in Table 6.

TABLE 6
For SU-MIMO (or MU-MIMO having equal bandwidth resource allocation)

| | CS | | | | OCC | | | |
|---|---|---|---|---|---|---|---|---|
| CS field value in | First | Second | Third | Fourth | First | Second | Third | Fourth |
| uplink related | layer | layer | layer | layer | layer | layer | layer | layer |
| DCI format | (Layer 0) | (Layer 1) | (Layer 2) | (Layer 3) | (Layer 0) | (Layer 1) | (Layer 2) | (Layer 3) |
| 000 | 0 | 3 | 6 | 9 | 0 | 1 | 0 | 1 |
| 001 | 6 | 9 | 0 | 3 | 1 | 0 | 1 | 0 |
| 010 | 3 | 6 | 9 | 0 | 1 | 0 | 1 | 0 |
| 011 | 4 | 7 | 10 | 1 | 0 | 1 | 0 | 1 |
| 100 | 2 | 5 | 8 | 11 | 0 | 1 | 0 | 1 |
| 101 | 8 | 11 | 2 | 5 | 1 | 0 | 1 | 0 |
| 110 | 10 | 1 | 4 | 7 | 1 | 0 | 1 | 0 |
| 111 | 9 | 0 | 3 | 6 | 0 | 1 | 0 | 1 |

As in step S428, when a UE-specific SGH is disabled, a CS/OCC mapping table for each layer is configured by applying a ‘second CS offset value allocation rule and OCC mapping rule’ and taking into consideration that this corresponds to an OCC mapping rule that is applicable to an MU-MIMO environment (particularly, an MU-MIMO environment with non-equal bandwidth resource allocation). In this example, the CS offset value allocation rule may be configured in accordance with one of the schemes expressed in Equation 3 and Equation 4, and the OCC mapping rule may be configured in accordance with the scheme expressed in Equation 7. In this example, an example of the CS/OCC mapping table for each layer configured by applying the ‘second CS offset value allocation rule and OCC mapping rule’ is as shown in Table 7.

TABLE 7
For MU-MIMO (particularly, for MU-MIMO with non-equal
bandwidth resource allocation)

| | CS | | | | OCC | | | |
|---|---|---|---|---|---|---|---|---|
| CS field value | First | Second | Third | Fourth | First | Second | Third | Fourth |
| in uplink related | layer | layer | layer | layer | layer | layer | layer | layer |
| DCI format | (Layer 0) | (Layer 1) | (Layer 2) | (Layer 3) | (Layer 0) | (Layer 1) | (Layer 2) | (Layer 3) |
| 000 | 0 | 3 | 6 | 9 | 0 | 0 | 0 | 0 |
| 001 | 6 | 9 | 0 | 3 | 1 | 1 | 1 | 1 |
| 010 | 3 | 6 | 9 | 0 | 1 | 1 | 1 | 1 |
| 011 | 4 | 7 | 10 | 1 | 0 | 0 | 0 | 0 |
| 100 | 2 | 5 | 8 | 11 | 0 | 0 | 0 | 0 |
| 101 | 8 | 11 | 2 | 5 | 1 | 1 | 1 | 1 |
| 110 | 10 | 1 | 4 | 7 | 1 | 1 | 1 | 1 |
| 111 | 9 | 0 | 3 | 6 | 0 | 0 | 0 | 0 |

That is, a user equipment also determines whether a UE-specific SGH transferred from an upper stage through an upper layer signaling, for example, an RRC, is enabled or disabled, and calculates a CS value and an OCC value for each layer in step S465. When the UE-specific SGH is enabled, Table 6 may be applied as in step S427. When the UE-specific SGH is disabled, Table 7 may be applied as in step S428. Also, it may be determined based on a predetermined RRC parameter value of 1 bit by separately defining the predetermined RRC parameter that is different from an RRC value for the UE-specific SGH.

FIG. 5 is a diagram illustrating a process that generates and transmits a DM-RS using a parameter value transmitted and received in an upper layer signaling according to another embodiment of the present invention.

The process of FIG. 5 may change an OCC mapping rule based on a predetermined RRC parameter value of 1 bit transferred from an upper stage through an upper layer signal, for example, an RRC. When a value of the predetermined RRC parameter corresponds to 0, a CS/OCC mapping table is configured for each layer by applying a ‘first CS offset value allocation rule and OCC mapping rule’. In this example, the CS offset value allocation rule is based on one of the schemes expressed in Equation 3 and Equation 4. In the case of the OCC mapping rule, 4 CSI values (or CS values) are based on Equation 5 and remaining 4 CSI values (or CS values) are based on Equation 7. In this example, an embodiment of a CS/OCC mapping table for each layer configured by applying the ‘first CS offset value allocation rule and OCC mapping rule’ is as shown in Table 8.

TABLE 8
A case in which a predetermined RRC parameter corresponds to 0

| | CS | | | | OCC | | | |
|---|---|---|---|---|---|---|---|---|
| CS field value | First | Second | Third | Fourth | First | Second | Third | Fourth |
| in uplink related | layer | layer | layer | layer | layer | layer | layer | layer |
| DCI format | (Layer 0) | (Layer 1) | (Layer 2) | (Layer 3) | (Layer 0) | (Layer 1) | (Layer 2) | (Layer 3) |
| 000 | 0 | 6 | 3 | 9 | 0 | 0 | 1 | 1 |
| 001 | 6 | 0 | 9 | 3 | 1 | 1 | 0 | 0 |
| 010 | 3 | 9 | 6 | 0 | 1 | 1 | 0 | 0 |
| 011 | 4 | 10 | 7 | 1 | 0 | 0 | 0 | 0 |
| 100 | 2 | 8 | 5 | 11 | 0 | 0 | 0 | 0 |
| 101 | 8 | 2 | 11 | 5 | 1 | 1 | 1 | 1 |
| 110 | 10 | 4 | 1 | 7 | 1 | 1 | 1 | 1 |
| 111 | 9 | 3 | 0 | 6 | 0 | 0 | 1 | 1 |

When a value of the predetermined RRC parameter corresponds to 1, a CS/OCC mapping table for each layer is configured by applying a ‘second CS offset value allocation rule and OCC mapping rule’. In this example, the CS offset value allocation rule is based on one of the schemes expressed in Equation 3 and Equation 4. In the case of the OCC mapping rule, 4 CSI values (or CS values) are based on Equation 6 and remaining 4 CSI values (or CS values) are based on Equation 7. In this example, an example of a CS/OCC mapping table for each layer configured by applying the ‘second CS offset value allocation rule and OCC mapping rule’ is as shown in Table 9

TABLE 9
A case in which a predetermined RRC parameter corresponds to 1

| | CS | | | | OCC | | | |
|---|---|---|---|---|---|---|---|---|
| CS field value | First | Second | Third | Fourth | First | Second | Third | Fourth |
| in uplink related | layer | layer | layer | layer | layer | layer | layer | layer |
| DCI format | (Layer 0) | (Layer 1) | (Layer 2) | (Layer 3) | (Layer 0) | (Layer 1) | (Layer 2) | (Layer 3) |
| 000 | 0 | 3 | 6 | 9 | 0 | 1 | 0 | 1 |
| 001 | 6 | 9 | 0 | 3 | 1 | 0 | 1 | 0 |
| 010 | 3 | 6 | 9 | 0 | 1 | 0 | 1 | 0 |
| 011 | 4 | 7 | 10 | 1 | 0 | 0 | 0 | 0 |
| 100 | 2 | 5 | 8 | 11 | 0 | 0 | 0 | 0 |
| 101 | 8 | 11 | 2 | 5 | 1 | 1 | 1 | 1 |
| 110 | 10 | 1 | 4 | 7 | 1 | 1 | 1 | 1 |
| 111 | 9 | 0 | 3 | 6 | 0 | 1 | 0 | 1 |

That is, a user equipment also calculates a CS value and an OCC value for each layer by determining information (predetermined RRC parameter) received through an upper layer signaling in step S565. For example, as in step S527, when a value of the predetermined RRC parameter corresponds to 0, Table 8 may be applied based on the ‘first CS offset value allocation rule and OCC mapping rule’. As in step S528, when the value of the predetermined RRC parameter corresponds to 1, Table 9 may be applied based on the ‘second CS offset value allocation rule and OCC mapping rule’. As opposed to the drawings, when the value of the predetermined RRC parameter corresponds to 1, Table 8 may be applied based on the ‘first CS offset value allocation rule and OCC mapping rule’. When the value of the predetermined RRC parameter corresponds to 0, Table 9 may be applied based on the ‘second CS offset value allocation rule and OCC mapping rule’.

Also, Table 6 and Table 7 as illustrated in FIG. 4 are also applicable. For example, when the value of the predetermined RRC parameter corresponds to 0, Table 6 may be applied based on the ‘first CS offset value allocation rule and OCC mapping rule’. When the value of the predetermined RRC parameter corresponds to 1, Table 7 may be applied based on the ‘second CS offset value allocation rule and OCC mapping rule’. Also, conversely, when the value of the predetermined RRC parameter corresponds to 1, Table 6 may be applied based on the ‘first CS offset value allocation rule and OCC mapping rule’. When the value of the predetermined RRC parameter corresponds to 0, Table 7 may be applied based on the ‘second CS offset value allocation rule and OCC mapping rule’. A relationship between a parameter and an allocation rule may be applied differently in an embodying process.

When a CS value and an OCC value are calculated for each layer as in step S465 and step S565 of FIG. 4 and FIG. 5, subsequent steps S470 through S490 and steps S570 through S590 may be performed. A UL DM-RS sequence is generated from a base sequence r̅_{u,v}(n) generated in advance and a CS (Cyclic Shift) value α determined for each layer, as shown in Equation 1, and the generated UL DM-RS sequence and a sequence value (+1 or −1) in an OCC index determined for each layer are multiplied so that a final UL DM-RS sequence is generated in step S470 and step S570.

Subsequently, the generated DM-RS sequence is mapped to a corresponding symbol of each slot through a resource element mapper in step S480 and step S580. In a case where the DM-RS is associated with a PUSCH, when a normal CP (Cyclic Prefix) is used, the corresponding symbol corresponds to the fourth symbol from among 7 symbols of each slot, and when an extended CP (Cyclic Prefix) is used, the corresponding symbol corresponds to a third symbol from among the symbols of each slot. When the DM-RS is associated with a PUCCH, the corresponding symbol corresponds to up to three symbols in each slot, and a location and the number of the corresponding symbols may be different based on a type of a CP and a PUCCH format.

An SC-FDMA symbol is generated, through an SC-FDMA generator, from an RE (Resource element) to which the DM-RS sequence is mapped, and a DM-RS signal is transmitted to a base station in step S490 and step S590.

When the OCC mapping rule is configured based on each MIMO environment through FIGS. 4 and 5, that is, when at least two mapping rules, such as an OCC mapping rule appropriate for an SU-MIMO and an OCC mapping rule appropriate for an MU-MIMO, are configured, 4 or 8 selectable CSI values may be secured.

For example, when Table 6 and Table 7 are applied, a CSI value may be selected from among 8 values based on Table 6 in a case of an SU-MIMO (ranks 2, 3, and 4), and a CSI value may be selected from among 8 values based on Table 7 in a case of an MU-MIMO (ranks 1, 2, 3, and 4). Also, the OCC mapping rule is configured based on each MIMO environment and thus, an orthogonality may be improved.

Also, when Table 8 and Table 9 are applied, a CSI value may be selected from among 4 values (000, 001, 010, and 111 from among CSI values of Table 9) in a case of an SU-MIMO and ranks are 3 and 4. Also, a CSI may be selected from among 8 values by applying Table 8 in a case of an MU-MIMO and ranks are 1, 2, 3, and 4. In a case of an SU-MIMO and ranks are 2, 3, and 4, a CSI may be selected from among four values (000, 001, 010, and 111 from among CS values of Table 9). Also, in a case of an MU-MIMO and ranks are 1, 2, 3, and 4, a CSI may be selected from among four values (011, 100, 101, and 110) by applying Table 9.

Equations 3 and 4 are associated with allocation of a cyclic shift value, and Equations 5, 6, and 7 are associated with a rule for allocating an OCC for each layer. In this example, in Equation 5, a first layer and a second layer have an identical OCC value and a third layer and a fourth layer have an identical OCC value, but the first layer and the third layer have different OCC values. In Equation 6, a first layer and a third layer have an identical OCC value and a second layer and a fourth layer have an identical OCC value, but the first layer and the second layer have different OCC values. In Equation 7, a first layer, a second layer, a third layer, and a fourth layer have an identical OCC value.

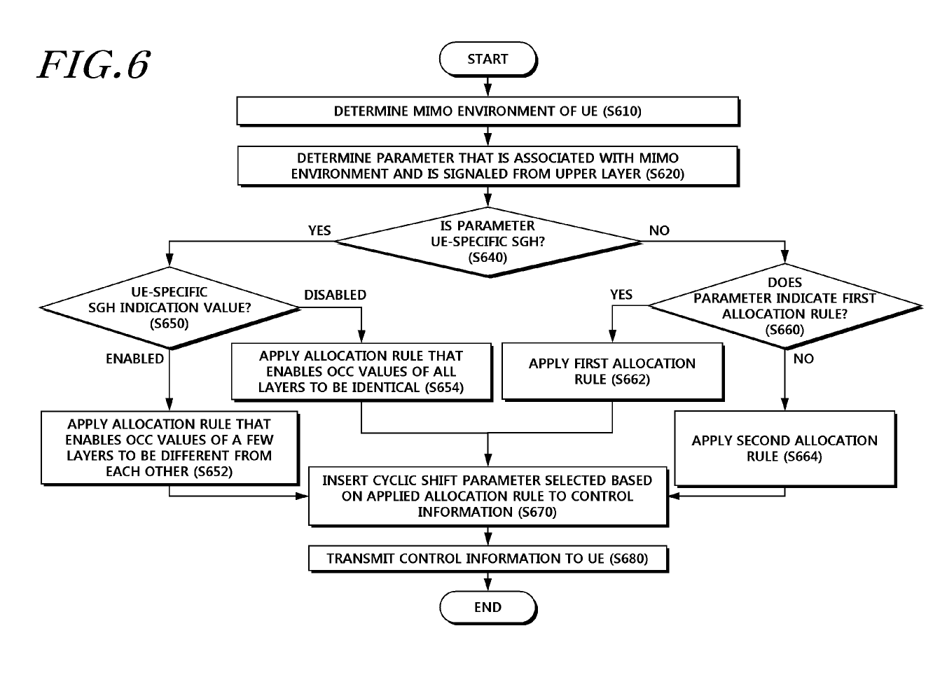

FIG. 6 is a diagram illustrating a process in which a base station selects an allocation rule based on an MIMO environment or operation mode of a user equipment, and transmits a cyclic shift parameter selected based on selected allocation rule to the user equipment according to an embodiment of the present invention.

The base station determines an MIMO environment of the UE in step S610. Also, the base station determines the MIMO environment, that is, a parameter that is associated with an MIMO operation mode and is signaled from an upper layer in step S620. When the determined parameter corresponds to a UE-specific SGH, the process of FIG. 4 is performed, and when the determined parameter corresponds to a separate parameter, the process of FIG. 5 is performed in step S640.

Referring to FIG. 4, when an indication value of the UE-specific SGH is determined to be enabled in the process of determining the parameter that indicates the UE-specific SGH, a cyclic shift allocation rule may be applied by applying Equation 3 or Equation 4 and an allocation rule is applied so that OCC values of a few layers are different from each other as illustrated in Equation 5 or Equation 6 in step S652. An embodiment of the result may be expressed by Table 6.

When the indication value of the UE-specific SGH is determined to be disabled in the process of determining the parameter that indicates the UE-specific SGH, a cyclic shift allocation rule may be applied by applying Equation 3 or Equation 4 and an allocation rule is applied so that OCC values for all layers are identical as illustrated in Equation 7 in step S654. An embodiment of the result may be expressed by Equation 7.

Referring to FIG. 5, whether the parameter in step S640 indicates a first allocation rule is determined in step S660. When the parameter is set to apply the first allocation rule (in FIG. 5, a case where the parameter corresponds to 0), the first allocation rule is applied in step S662. Conversely, when the parameter is set to apply a second allocation rule (in FIG. 5, a case where the parameter corresponds to 1), the second allocation rule is applied in step S664. The parameter is a value agreed in advance between the base station and the user equipment and thus, the value may be changed. The first allocation rule and the second allocation rule include various results that may be calculated by applying Equations 3 and 4, and Equations 5, 6, and 7. As an example, Table 8 and Table 9 may correspond to the first allocation rule and the second allocation rule, respectively. As another example, Table 6 and Table 7 may correspond to the first allocation rule and the second allocation rule, respectively.

When the application of an allocation rule is completed, a cyclic shift parameter selected based on the applied allocation rule is inserted into control information in step S670. According to an embodiment of the present invention, it may be included in a DCI (Downlink Control Information) format 0 of a PDCCH (Physical Data Control Channel).

The control information is transmitted to the UE in step S680. The UE that receives the control information may determine information associated with an orthogonality from a set where a cyclic shift is included. Also, the user equipment determines or estimates whether a connection status corresponds to an SU-MIMO or an MU-MIMO, and may select an orthogonality allocation rule based on the determination. Also, an OCC may be set for each layer based on the selected orthogonality allocation rule and the determined information associated with the orthogonality.

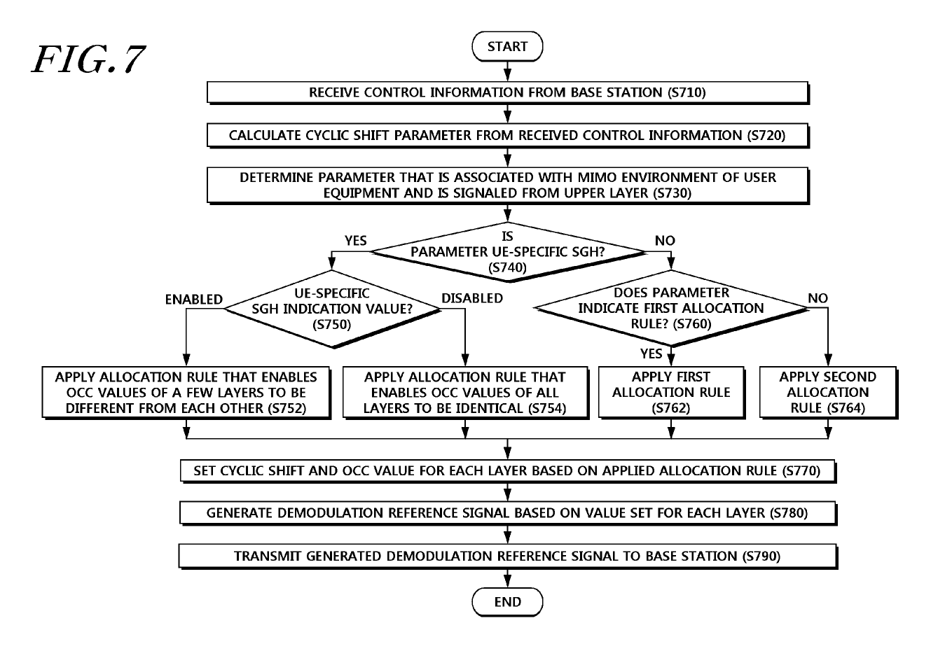

FIG. 7 is a diagram illustrating a process in which a user equipment selects an allocation rule based on a received cyclic shift parameter and an MIMO environment or operation mode, and transmits a demodulation reference signal generated based on the selected allocation rule to a base station according to an embodiment of the present invention.

Control information is received from the base station in step S710. According to an embodiment of the present invention, the control information may be included in a DCI (Downlink Control Information) format 0 of a PDCCH (Physical Data Control Channel).

A cyclic shift parameter is calculated from the received control information in step S720. A parameter that is associated with an MIMO environment of the user equipment and is signaled from an upper layer is determined in step S730. When the determined parameter corresponds to a UE-specific SGH, the process of FIG. 4 is performed, and when the determined parameter corresponds to a separate parameter, the process of FIG. 5 is performed in step S740.

Referring to FIG. 4, when an indication value of the UE-specific SGH is determined to be enabled in the process of determining the parameter that indicates the UE-specific SGH, a cyclic shift allocation rule may be applied by applying Equation 3 or Equation 4 and an allocation rule is applied so that OCC values of a few layers are different from each other as illustrated in Equation 5 or Equation 6 in step S752. An embodiment of the result may be expressed by Table 6.

When the indication value of the UE-specific SGH is determined to be disabled in the process of determining the parameter that indicates the UE-specific SGH, a cyclic shift allocation rule may be applied by applying Equation 3 or Equation 4 and an allocation rule is applied so that OCC values for all layers are identical as illustrated in Equation 7 in step S754. An embodiment of the result may be expressed by Equation 7.

Referring to FIG. 5, whether the parameter in step S640 indicates a first allocation rule is determined in step S760. When the parameter is set to apply the first allocation rule (in FIG. 5, a case where the parameter corresponds to 0), the first allocation rule is applied in step S762. Conversely, when the parameter is set to apply a second allocation rule (in FIG. 5, a case where the parameter corresponds to 1), the second allocation rule is applied in step S664. The parameter is a value agreed in advance between the base station and the user equipment and thus, the value may be changed. The first allocation rule and the second allocation rule include various results that may be calculated by applying Equations 3 and 4, and Equations 5, 6, and 7. As an example, Table 8 and Table 9 may correspond to the first allocation rule and the second allocation rule, respectively. As another example, Table 6 and Table 7 may correspond to the first allocation rule and the second allocation rule, respectively.

When the application of an allocation rule is completed, the user equipment may set a cyclic shift parameter and an OCC value for each layer based on the applied allocation rule in step S770. The user equipment generates a demodulation reference signal based on the value set for each layer in step S780, and transmits the generated demodulation reference signal to the base station in step S790.

To apply FIGS. 6 and 7, Equations 3, 4, 5, 6, and 7 and Tables 6, 7, 8, and 9 may be applied as an embodiment.

Equations 3 and 4 are associated with a process that sets a cyclic shift of a first layer based on a received cyclic shift parameter, and sets cyclic shifts with respect to remaining layers to have separations of 3/6/9 from each other.

Equations 5, 6, and 7 are associated with a process that sets an OCC value matching a cyclic shift value of a first layer based on a cyclic shift parameter, and sets OCC values with respect to remaining layers to have an identical OCC value or different OCC values based on a relationship with the first layer.

Therefore, various mapping rules may be calculated by applying Equations 3 and 4 and Equations 5, 6, and 7. Also, a parameter associated with an MIMO environment that is used for selecting a mapping rule may also be variously selected. In the present specifications, it may be selected through a parameter of 1 bit or a value of a UE-specific SGH, transferred through an RRC signaling.

At least two mapping rules may be calculated for each case, and an embodiment of the present invention describes selecting one of two mapping rules. When a variety of information is transferred through the RRC signaling, one from among two or more mapping rules may be selected.

According to an embodiment of the present invention, two mapping rules form a pair and one of the two mapping rules is selected, and the two mapping rules forming a pair may be as follows.

### First Embodiment

A process that selects one of two mapping rules based on Table 6 and Table 7 has been described with reference to FIG. 4.

### Second Embodiment

A process that selects one of two mapping rules based on Table 8 and Table 9 has been described with reference to FIG. 5.

### Third Embodiment

A process selects one of two mapping rules generated by applying Equation 3 and Equations 5, 6, and 7, and FIG. 4 may be applied using the following two tables.

TABLE 10
For SU-MIMO (or MU-MIMO having equal bandwidth resource allocation)

| | CS | | | | OCC | | | |
|---|---|---|---|---|---|---|---|---|
| CS field value | First | Second | Third | Fourth | First | Second | Third | Fourth |
| in uplink related | layer | layer | layer | layer | layer | layer | layer | layer |
| DCI format | (Layer 0) | (Layer 1) | (Layer 2) | (Layer 3) | (Layer 0) | (Layer 1) | (Layer 2) | (Layer 3) |
| 000 | 0 | 6 | 3 | 9 | 0 | 1 | 0 | 1 |
| 001 | 6 | 0 | 9 | 3 | 1 | 0 | 1 | 0 |
| 010 | 3 | 9 | 6 | 0 | 1 | 0 | 1 | 0 |
| 011 | 4 | 10 | 7 | 1 | 0 | 1 | 0 | 1 |
| 100 | 2 | 8 | 5 | 11 | 0 | 1 | 0 | 1 |
| 101 | 8 | 2 | 11 | 5 | 1 | 0 | 1 | 0 |
| 110 | 10 | 4 | 1 | 7 | 1 | 0 | 1 | 0 |
| 111 | 9 | 3 | 0 | 6 | 0 | 1 | 0 | 1 |

TABLE 11
For MU-MIMO (particularly, for MU-MIMO with non-equal
resource allocation environment)

| | CS | | | | OCC | | | |
|---|---|---|---|---|---|---|---|---|
| CS field value | First | Second | Third | Fourth | First | Second | Third | Fourth |
| in uplink related | layer | layer | layer | layer | layer | layer | layer | layer |
| DCI format | (Layer 0) | (Layer 1) | (Layer 2) | (Layer 3) | (Layer 0) | (Layer 1) | (Layer 2) | (Layer 3) |
| 000 | 0 | 6 | 3 | 9 | 0 | 0 | 0 | 0 |
| 001 | 6 | 0 | 9 | 3 | 1 | 1 | 1 | 1 |
| 010 | 3 | 9 | 6 | 0 | 1 | 1 | 1 | 1 |
| 011 | 4 | 10 | 7 | 1 | 0 | 0 | 0 | 0 |
| 100 | 2 | 8 | 5 | 11 | 0 | 0 | 0 | 0 |
| 101 | 8 | 2 | 11 | 5 | 1 | 1 | 1 | 1 |
| 110 | 10 | 4 | 1 | 7 | 1 | 1 | 1 | 1 |
| 111 | 9 | 3 | 0 | 6 | 0 | 0 | 0 | 0 |

### Fourth Embodiment

A process selects one of two mapping rules generated by applying Equations 3 and 4 and Equations 5, 6, and 7, and FIG. 5 may be applied using the following two tables.

TABLE 12
A case in which a predetermined RRC parameter corresponds to 0

| | CS | | | | OCC | | | |
|---|---|---|---|---|---|---|---|---|
| CS field value | First | Second | Third | Fourth | First | Second | Third | Fourth |
| in uplink related | layer | layer | layer | layer | layer | layer | layer | layer |
| DCI format | (Layer 0) | (Layer 1) | (Layer 2) | (Layer 3) | (Layer 0) | (Layer 1) | (Layer 2) | (Layer 3) |
| 000 | 0 | 6 | 3 | 9 | 0 | 1 | 0 | 1 |
| 001 | 6 | 0 | 9 | 3 | 1 | 0 | 1 | 0 |
| 010 | 3 | 9 | 6 | 0 | 1 | 0 | 1 | 0 |
| 011 | 4 | 10 | 7 | 1 | 0 | 0 | 0 | 0 |
| 100 | 2 | 8 | 5 | 11 | 0 | 0 | 0 | 0 |
| 101 | 8 | 2 | 11 | 5 | 1 | 1 | 1 | 1 |
| 110 | 10 | 4 | 1 | 7 | 1 | 1 | 1 | 1 |
| 111 | 9 | 3 | 0 | 6 | 0 | 1 | 0 | 1 |

TABLE 13
A case in which a predetermined RRC parameter corresponds to 1

| | CS | | | | OCC | | | |
|---|---|---|---|---|---|---|---|---|
| CS field value | First | Second | Third | Fourth | First | Second | Third | Fourth |
| in uplink related | layer | layer | layer | layer | layer | layer | layer | layer |
| DCI format | (Layer 0) | (Layer 1) | (Layer 2) | (Layer 3) | (Layer 0) | (Layer 1) | (Layer 2) | (Layer 3) |
| 000 | 0 | 3 | 6 | 9 | 0 | 0 | 1 | 1 |
| 001 | 6 | 9 | 0 | 3 | 1 | 1 | 0 | 0 |
| 010 | 3 | 6 | 9 | 0 | 1 | 1 | 0 | 0 |
| 011 | 4 | 7 | 10 | 1 | 0 | 0 | 0 | 0 |
| 100 | 2 | 5 | 8 | 11 | 0 | 0 | 0 | 0 |
| 101 | 8 | 11 | 2 | 5 | 1 | 1 | 1 | 1 |
| 110 | 10 | 1 | 4 | 7 | 1 | 1 | 1 | 1 |
| 111 | 9 | 0 | 3 | 6 | 0 | 0 | 1 | 1 |

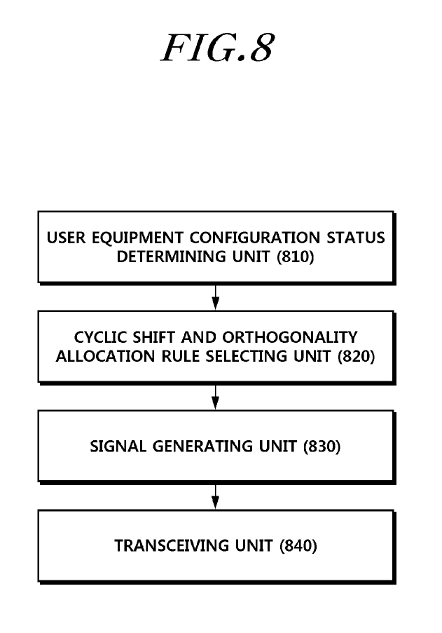

FIG. 8 is a diagram illustrating a configuration of an apparatus for transmitting a cyclic shift parameter according to an embodiment of the present invention. The configuration of FIG. 8 may correspond to a base station.

The configuration includes a user equipment configuration status determining unit 810, a cyclic shift and orthogonality allocation rule selecting unit 820, a signal generating unit 830, and a transceiving unit 840.

The user equipment configuration status determining unit 810 determines an MIMO environment of the user equipment. Whether the MIMO environment corresponds to an SU-MIMO or an MU-MIMO, a rank, and the like may be determined.

The cyclic shift and orthogonality allocation rule selecting unit 820 selects a cyclic shift and orthogonality allocation rule appropriate for the determined MIMO environment based on a parameter that is associated with the MIMO environment and is signaled from an upper layer. For example, the cyclic shift and orthogonality allocation rule selecting unit 820 selects a first allocation rule or a second allocation rule based on a value of the parameter as is illustrated in FIG. 5, and each the first allocation rule and the second allocation rule selects a different one from Table 6 and Table 7, or selects a different one from Table 8 and Table 9. Each pair of selectable mapping rules may correspond to Table 10 and Table 11, and Table 12 and Table 13, in addition to Table 6 and Table 7, and Table 8 and Table 9.

Also, in a case where the signaled parameter corresponds to an indication value of a UE-specific SGH (sequence and sequence group hopping), when the indication value of the UE-specific SGH is enabled, the cyclic shift and orthogonality allocation rule selecting unit 820 is embodied to select Table 6 as an allocation rule, and when the indication value of the UE-specific SGH is disabled, the cyclic shift and orthogonality allocation rule selecting unit 820 is embodied to select Table 7 as an allocation rule.

In other words, the MIMO environment of the user equipment may include an SU-MIMO and an MU-MIMO. In a case of the SU-MIMO, ranks may correspond to 2, 3, and 4. In a case of the MU-MIMO, ranks may correspond to 1, 2, 3, and 4. Accordingly, OCC values may be set for 1 through 4 layers.

Therefore, when the MIMO environment of the user equipment corresponds to an SU-MIMO, the selected orthogonality allocation rule may apply Equation 6 in which OCC values of a first layer and a second layer are different from each other, OCC values of a third layer and a fourth layer are different from each other, and the OCC values of the first layer and the third layer are identical. As another example, the selected orthogonality allocation rule may is apply Equation 5 in which OCC values of a first layer and a second layer are identical, OCC values of a third layer and a fourth layer are identical, and OCC values of the first layer and the third layer are different from each other.

When the MIMO environment of the user equipment corresponds to an MU-MIMO, the selected orthogonality allocation rule may apply Equation 7 in which OCC values of all layers are identical.

The signal generating unit 830 generates a signal that is to be used for transmitting, to the user equipment, control information in which a cyclic shift parameter determined based on the selected allocation rule is included. The transceiving unit 840 transmits the signal to the user equipment. Subsequently, the transceiving unit 840 may receive, from the user equipment, a reference signal generated by applying the cyclic shift parameter.

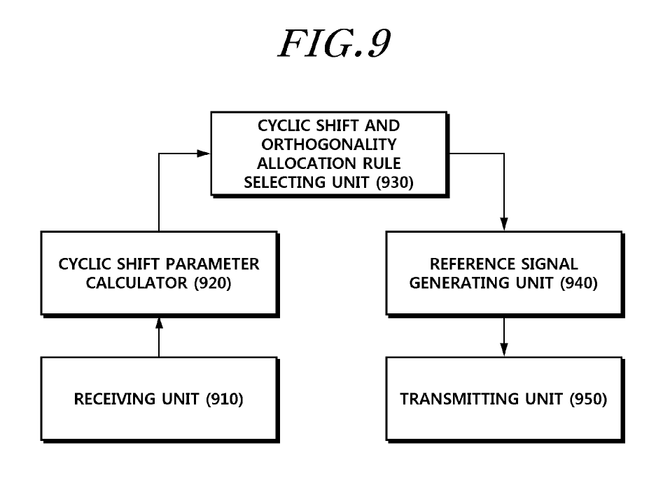

FIG. 9 is a diagram illustrating a configuration of an apparatus for transmitting a reference signal that satisfies an orthogonality by receiving a cyclic shift parameter according to an embodiment of the present invention. The embodiment of FIG. 9 may be applied to a user equipment.

The configuration includes a receiving unit 910, a cyclic shift parameter calculator 920, a cyclic shift and orthogonality allocation rule selecting unit 930, a reference signal generating unit 940, and a transmitting unit 950.

The receiving unit 910 receives control information from a base station. In this example, receiving control information includes receiving a wireless signal including control information. The control information may be included in a PDCCH for transmission.

The cyclic shift parameter calculator 920 calculates a cyclic shift parameter from the control signal that the receiving unit 910 receives. When the control information is included in the PDCCH and transmitted, may be included in a DCI format 0 as the cyclic shift parameter.

The cyclic shift and orthogonality-related information selecting unit 930 determines a parameter that is associated with an MIMO environment of the user equipment and is signaled from an upper layer, and selects a cyclic shift and orthogonality allocation rule based on the determined parameter and the cyclic shift parameter.

For example, the cyclic shift and orthogonality-related information selecting unit 930 selects a first allocation rule or a second allocation rule based on a value of the parameter as illustrated in FIG. 5, and each the first allocation rule and the second allocation rule selects a different one from Table 6 and Table 7, or selects a different one from Table 8 and Table 9. Each pair of selectable mapping rules may correspond to Table 10 and Table 11, and Table 12 and Table 13, in addition to Table 6 and Table 7, Table 8 and Table 9.

Also, in a case where the signaled parameter corresponds to an indication value of a UE-specific SGH (sequence and sequence group hopping), when the indication value of the UE-specific SGH is enabled, the cyclic shift and orthogonality allocation rule selecting unit 930 is embodied to select Table 6 as an allocation rule, and when the indication value of the UE-specific SGH is disabled, the cyclic shift and orthogonality allocation rule selecting unit 930 is embodied to select Table 7 as an allocation rule.

In other words, the MIMO environment of the user equipment may include an SU-MIMO and an MU-MIMO. In the case of the SU-MIMO, ranks may correspond to 2, 3, and 4. In a case of the MU-MIMO, ranks may correspond to 1, 2, 3, and 4. Accordingly, OCC values may be set for 1 through 4 layers.

Therefore, when the MIMO environment of the user equipment corresponds to an SU-MIMO, the selected orthogonality allocation rule may apply Equation 6 in which OCC values of a first layer and a second layer are different from each other, OCC values of a third layer and a fourth layer are different from each other, and the OCC values of the first layer and the third layer are identical. As another example, the selected orthogonality allocation rule may apply Equation 5 in which OCC values of a first layer and a second layer are identical, OCC values of a third layer and a fourth layer are identical, and OCC values of the first layer and the third layer are different from each other.

When the MIMO environment of the user equipment corresponds to an MU-MIMO, the selected orthogonality allocation rule may apply Equation 7 in which OCC values of all layers are identical.

The reference signal generating unit 940 generates a reference signal by setting a cyclic shift value and an OCC value for each layer using the cyclic shift parameter received based on the selected allocation rule, and the transmitting unit 950 transmits the generated reference signal to the base station.

In the present specifications, in a case where an OCC mapping rule is selected one of two or more mapping rules and is configured based on each MIMO environment, that is, in a case where at least two mapping rules, such as an OCC mapping rule appropriate for an SU-MIMO and an OCC mapping rule appropriate for an MU-MIMO, are configured, when the mapping rules are linked with a CS parameter value (CSI value) n_{DMRS}⁽²⁾, CS parameter values (CSI values) that are allocable to each UE may be varied.

In a case where a single mapping rule is used, when an OCC mapping rule (Equation 6) that takes into consideration applying of an OCC in a rank 2 in an SU-MIMO is applied to 2 CS parameter values from among a total of 8 allocable CS parameter values (CSI values), an OCC mapping rule (Equation 5) appropriate for ranks 3 and 4 in an SU-MIMO and ranks 1 and 2 in an MU-MIMO is applied to another 2 CS parameter values, and an OCC mapping rule (Equation 7) appropriate for transmission of ranks 1, 2, 3, and 4 of an MU-MIMO is applied to remaining 4 CS parameter values, a number of CS parameter values (CSI values) allocable to a corresponding UE in each MIMO environment may be reduced to down 2 from 8, which may cause a collision problem during PHICH (Physical Hybrid Indication Channel) resource allocation. However, the present specifications select a cyclic shift and orthogonality allocation rule including an OCC mapping rule from among two rules so that i) either one of Table 6 and Table 7 is selected, ii) either one of Table 8 and Table 9 is selected, iii) either one of Table 10 and Table 11 is selected, and iv) either one of Table 12 and Table 13 is selected for each user equipment as described in the foregoing. The tables are embodiments of a mapping rule of the present invention, and mapping rules having various forms and various values may be generated in addition to the tables. Also, a mapping rule may be selected from many mapping rules using various embodiments of the present invention so that a collision in resource allocation may be reduced.

That is, according to an embodiment of the present invention, a Cyclic Shift (CS) value and an OCC (Orthogonal Cover Code) may be allocated to be different for each layer using a predetermined RRC parameter value associated with a sequence and a sequence group hopping based on an MIMO environment or an RRC parameter value.

Accordingly, the present specifications may provide a method and apparatus for allocating a Cyclic Shift (CS) value of each layer of an Uplink (UL) Demodulation Reference Signal (DM-RS). When a base station (eNB and the like) provides (signals) a Cyclic Shift (CS) value of a first layer that is scheduled and determined in an upper stage, to a user equipment (UE) by including the CS value in a CS field of a PDCCH DCI format 0, the method and apparatus allocates Cyclic Shift (CS) values of other layers based on the value without additional signaling (implicit).

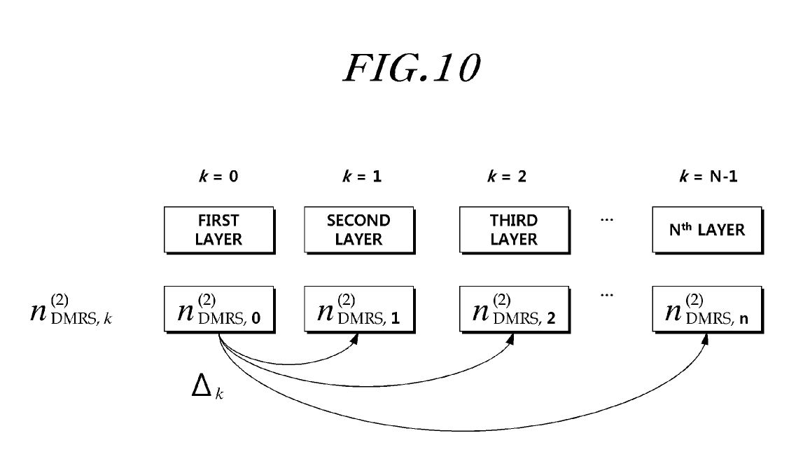

FIG. 10 is a diagram illustrating an example of allocating a CS value for each layer of a user equipment according to an embodiment of the present invention. FIG. 10 illustrates an example that sets cyclic shift parameters for remaining layers using a value of a cyclic shift parameter of a first layer (1st layer). Therefore, to clearly distinguish layers, a CS value to provide the greatest separation between layers is allocated, which will be described in detail as follows.

FIG. 10 shows a process that allocates cyclic shift values (n_{DNRS,k}⁽²⁾, k=0, 1, . . . , and N−1) with respect to N layers (a first, a second, . . . , an Nth layer). A cyclic shift value n_{DMRS}⁽²⁾, 0 for the first layer may be set by receiving a value of 3 bits from a base station as shown in Table 2. Each of the remaining layers (the second, the third, . . . , and Nth layer) may have an offset of Δₖ, so as to have a great separation from the cyclic shift value for the first layer, and Equation 8 may be applied.

n_{DMRS,0}⁽²⁾(CS value for 1st layer) ∈ {0,6,3,4,2,8,10,9};

n_{DMRS,k}⁽²⁾(CS value for (k+1)th layer) (k=0,1,2,3)=(n_{DMRS,0}⁽²⁾+Δₖ)mod12 [Equation 8]
1) CS offsets (Δₖ) for 2 layers are 0, 6 for k=0, 1
2) CS offsets (Δₖ) for 4 layers are 0, 6, 3, 9 (or 0, 6, 9, 3) for k=0, 1 2, 3
3) CS offsets (Δₖ) for 3 layers are
   Option 1 (embodiment 1)—0, 4, 8 (or 0, 8, 4) for k=0, 1, 2
   Option 2 (embodiment 2)—0, 6, 3 (or 0, 3, 6 or 0, 6, 9 or 0, 9, 6
      or 0, 3, 9 or 0, 9, 3) for k=0, 1, 2

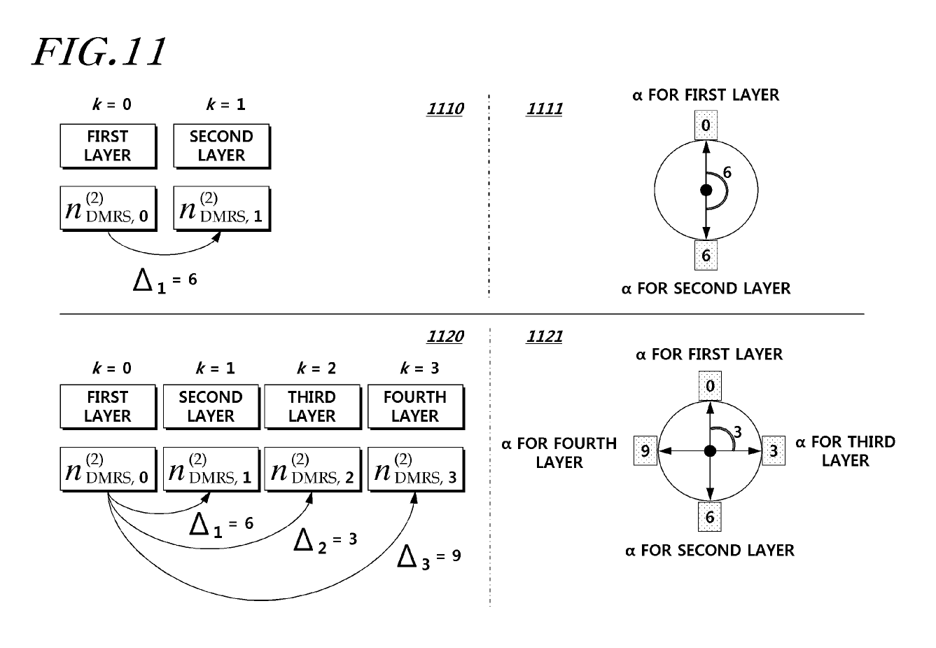

For example, one of a total of 8 values corresponding to 0,6,3,4,2,8,10, and 9 may be received from a Cyclic Shift indication (CSI) of 3 bits, as a CS value n_{DMRS,0}⁽²⁾ for a first layer, and a CS value n_{DMRS,k}⁽²⁾ for each of the remaining layers is given in a form of an offset Δₖ and the CS value n_{DMRS,0}⁽²⁾ for the first layer, based on a predetermined rule. For example, in a case where a rank is 2 since a total of 2 layers exist, when a CS value for a first layer is n_{DMRS,0}⁽²⁾ and a CS value for a second layer is (n_{DMRS}⁽²⁾+6)mod 12 (in this example, the offset Δₖ is 0 when k=0, and the offset Δₖ is 6 when k=1). 6 may provide the greatest separation between the two layers. In a case where a total of 4 layers exist (a rank is 4), when a CS value for a first layer is n_{DMRS,0}⁽²⁾, a CS value for a second layer is (n_{DMRS,0}⁽²⁾+6)mod 12, a CS value for a third layer is (n_{DNRS,0}⁽²⁾+3)mod 12, and a CS value for a fourth layer is (n_{DMRS,0}⁽²⁾+9)mod 12 (in this example, the offset Δₖ is 0 when k=0, the offset Δₖ is 6 when k=1, the offset k is 3 when k=2, and the offset Δₖ is 9 when k=3. This will be described in detail with reference to FIG. 11.

FIG. 11 is a diagram illustrating an example of allocating a CS value for each layer of a user equipment according to an embodiment of the present invention.

The diagram 1110 corresponds to a case in which a rank is 2. When a CS for a first layer is n_{DMRS,0}⁽²⁾, a CS value for a second layer is (n_{DMRS,0}⁽²⁾+6)mod 12 (in this example, the offset is 0 when k=0 and the offset Δₖ is 6 when k=1).

The diagram 1120 corresponds to a case in which a rank is 4. When a CS value for a first layer is n_{DMRS,0}⁽²⁾, a CS value for a second layer is (n_{DMRS,0}⁽²⁾+6)mod 12, a CS value for a third layer is (n_{DMRS,0}⁽²⁾+3)mod 12, and a CS value for a fourth layer is (n_{DMRS,0}⁽²⁾+9)mod 12 (in this example, the Δₖ is 0 when k=0, the Δₖ is 6 when k=1, the Δₖ is 3 when k=2, and the Δₖ is 9 when k=3).

It is determined that the separation of α calculated based on a cyclic shift parameter in the diagrams 1110 and 1120 is the greatest value, through Equation 2 and the diagrams 1111 and 1121. Also, in the diagrams 1120 and 1121 of FIG. 11, when K=0, 1, 2, and 3, 0, 6, 9, and 3 may be used as offsets, respectively.

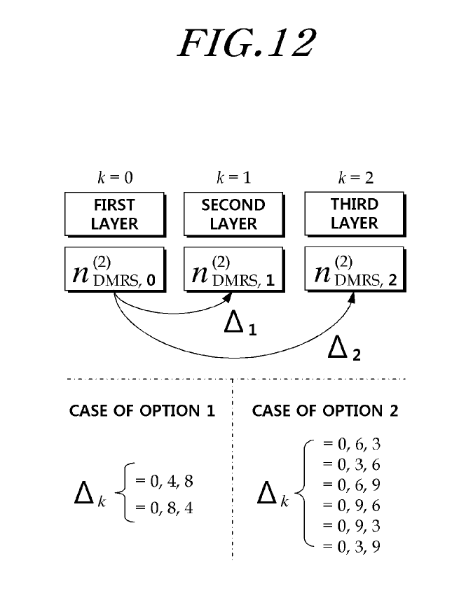

FIG. 12 is a diagram illustrating an example of allocating a CS value for each layer of a user equipment when a rank is 3 according to an embodiment of the present invention.

In a case in which the rank is 3, when a CS value for a first layer is n_{DMRS,0}⁽²⁾, a CS value for a second layer is (n_{DMRS,0}⁽²⁾+×1) mod 12. A CS value for a third layer is (n_{DMRS,0}⁽²⁾+×2)mod 12. Values for ×1 and >2 may be classified by an option 1 (CS allocation method 1) and an option 2 (CS allocation method 2). Selecting of the option may be agreed in advance between a base station and a user equipment or may be instructed using an upper layer signaling.

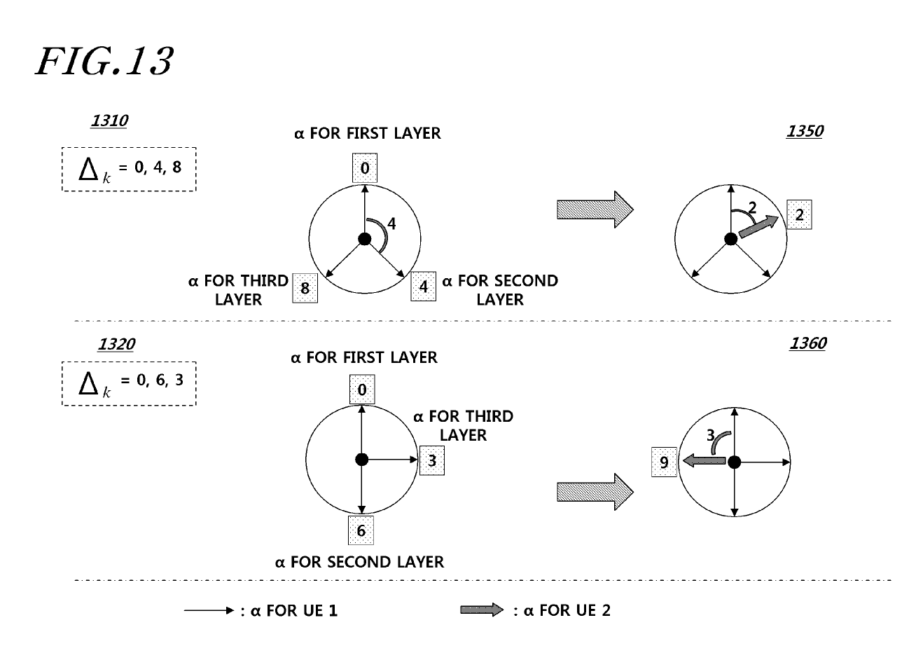

In the case of the option 1, as illustrated in Equation 8, when k is 0, 1, and 2, a value of Δₖ may correspond to {0, 4, 8} or {0, 8, 4}. In the case of the option 2, as illustrated in Equation 8, when k is 0, 1, and 2, the value of Δₖ may correspond to one of {0, 6, 3}, {0, 3, 6}, {0, 6, 9}, {0, 9, 6}, {0, 9, 3} and {0, 3, 9}. The separations obtained by applying option 1 and option 2 will be described with reference to FIG. 13.

FIG. 13 is a diagram illustrating a separation by a cyclic shift parameter when a rank is 3 according to an embodiment of the present invention.

The diagram 1310 corresponds to a case of an option 1, α for a first layer, a second layer, and a third layer may be determined when a value of Δₖ is { 0, 4, 8}. The diagram 1320 corresponds to a case of an option 2, α for a first layer, a second layer, and a third layer may be determined when a value of Δₖ is { 0, 6, 3}.

‘option 1’ provides the greatest separation (in this example, a separation of a CS is value is 4) between CSs in a UL DM-RS that uses a total of 12 CS values and thus may secure more orthogonality when compared to ‘option 2’. However, when bandwidths (BW) of two user equipments (UEs) are identical in an MU-MIMO (MU-MIMO with equal sized BW allocation) and a UE1 uses three layers (rank 3) and a UE 2 uses a single layer (rank 1), option 2 may be applied. As shown in the diagram 1350, when a UE that uses three layers is provided with the offset Δₖ of 0, 4, and 8 when k is 0, 1, and 2, respectively, based on option 1, the remaining

UE may separate a CS value by only 2 from the UE that uses three layers and thus, an orthogonality may be deteriorated.

Conversely, in a case of the diagram 1360 that uses option 2, when the UE1 that uses three layers is provided with the offset Δₖ of 0, 6, and 3 when k is 0, 1, and 2, respectively, and the UE2 that uses a single layer has a CS value of 9, a separation from the UE 1 that use three layers may be 3 and thus, an orthogonality may be more secured when compared to the option 2.

That is, a scheme of improving an orthogonality of a UL DM-RS may select either option 1 or option 2 based on a connection scheme of a user equipment or a connection status. Option 1 and option 2 may be agreed on in advance between a base station and a user equipment or may be instructed by an upper layer signaling and the like.

When bandwidths (BW) of two UEs are different from each other in an MU-MIMO (MU-MIMO with non-equal sized BW allocation), UL DM-RS sequences of the two UEs may use different base sequences from each other. When bandwidths are different, lengths of the base sequences are different. In a case of a Zadoff-Chu sequence-based base sequence, when lengths of the sequences are different, the sequences are different from each other. Therefore the securing of an orthogonality between UEs using a CS value becomes meaningless. In this example, the orthogonality between the UEs may be secured using only an OCC (Orthogonal Cover Code). Accordingly, in this example, option 1 that secures an orthogonality between layers in a single UE is more appropriate since distinguishing UEs using a CS is meaningless.

That is, option 1 and option 2 may be selected based on whether an MIMO environment is an SU-MIMO or an MU-MIMO, and may be selected based on when the MU-MIMO corresponds to an MU-MIMO with equal sized BW allocation or an MU-MIMO with non-equal sized BW allocation in a case of the MU-MIMO. That is, an orthogonality is provided based on a connection status of a UE and a feature of an allocated frequency domain and thus, the present specifications provide an apparatus and method for selecting between option 1 and option 2 based on the connection status of the UE and the feature of the allocated frequency domain. To achieve this, for example, a signaling associated with the use of option 1 or option 2 may be performed. In this example, when the signaling is performed by allocating an additional bit, an amount of information transmitted and received increases and thus a scheme that selects option 1 or option 2 may be performed without additional signaling (implicit).

In the present specifications, the connection status refers to a status in which a user equipment performs a connection based on an SU-MIMO mode or an MU-MIMO mode. Also, the connection status includes information associated with a number of layers used by a single user equipment or a rank used by the user equipment. That is, the connection status indicates connection modes and frequency bands used when the user equipments establish connection.

According to an embodiment of the present invention, a sequence and sequence group hopping method may be linked to a CS allocation method.

TABLE 14
Link between sequence/sequence group hopping method and option

| Sequence/sequence group hopping | |
|---|---|
| method | Option |
| First hopping method | Option 1 |
| | Offset for each layer |
| | {0, 4, 8} or {0, 8, 4} |
| Second hopping method | Option 2 |
| | Offset for each layer {0, 6, 3} or {0, |
| | 3, 6} |
| | or {0, 6, 9} or {0, 9, 6} |
| | or {0, 3, 9} or {0, 9, 3} |

Table 14 shows that option 1 and option 2 may be switched based on a hopping method.

An embodiment of the SGH (Sequence/Sequence Group Hopping) method is a method that operates in a cell-specific manner. The term ‘cell-specific’ indicates that the method operates specifically for each cell. When the hopping method is disabled, all UEs in a cell do not perform SGH, and when the hopping method is enabled, all UEs in the cell may perform SGH based on a slot unit. Whether the hopping scheme is to be disabled/enabled may be determined by a signaling from an upper stage.

However, when bandwidths (BW) of two UEs in an MU-MIMO use an MU-MIMO with non-equal sized BW allocation, an OCC may be used based on a slot unit to distinguish the two user equipments. In a case where the SGH is enabled, hopping is performed based on a slot unit. Although an OCC is applied, there is difficulty in distinguishing the two user equipments based on a sequence since a base sequence of a UL DM-RS sequence is changed during the hopping. Therefore, a hopping (SGH) scheme for this case (MU-MIMO with non-equal sized BW allocation) may be required and it may be classified into the following two embodiments.

An SGH scheme according to another embodiment of the present invention is a method that operates in a UE-specific manner, that is, operates specifically for each UE. For example, when the SGH is disabled, a corresponding UE does not perform SGH. When the SGH is enabled, the corresponding UE performs SGH based on a slot unit. That is, a UE corresponding to an MU-MIMO with non-equal sized BW allocation may disable the SGH, and may enable the SGH for another UE.

An SGH scheme according to another embodiment of the present invention is a method that adds a subframe unit-based hopping (SGH) scheme when the SGH is enabled. That is, in a case of the MU-MIMO with non-equal sized BW allocation, when the SGH is enabled, the SGH is performed based on a subframe unit. For other cases, when the SGH is enabled, the SGH is performed based on a slot unit. In this example, the two cases may be applicable when the SGH is enabled.

In a case where the option 1 is appropriate, the MU-MIMO with non-equal sized

BW allocation has a significantly close relationship with a sequence and sequence group hopping (SGH) for a UL DM-RS. Therefore, when the option 1 and the option 2 are linked to the sequence and sequence group hopping (SGH) method, a predetermined rule for allocating CS values to other layers may be appropriately selected and used without additional signaling.

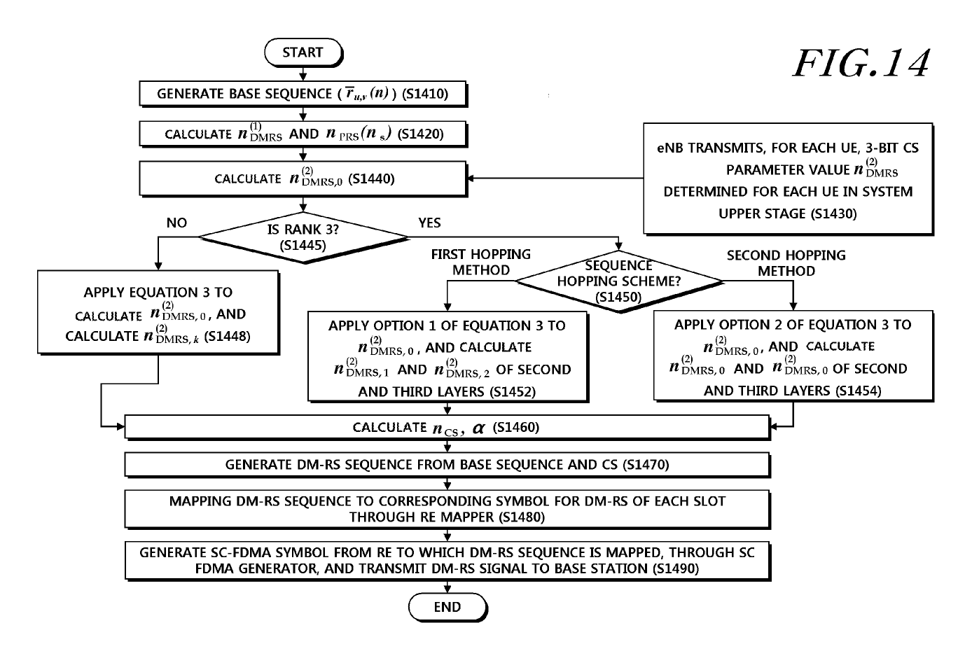

FIG. 14 is a diagram illustrating a process in which a user equipment selects a CS allocation rule linked to a sequence and sequence group hopping scheme and generates a DM-RS sequence. A zadoff-chu sequence-based base sequence is generated for a UL DM-RS by applying Equation 1 and Equation 2 in step S1410. n_{DMRS}⁽¹⁾ is calculated based on a value given from an upper layer and n_{PRS}(nₛ) is calculated by Equation 2 in step S1420. As in step S1430, a UE (user equipment) receives, from a base station and the like, a Cyclic Shift indication (CSI) value of 3 bits that is scheduled and determined in an upper stage, and the value of 3 bits may be included in a CS (Cyclic Shift) field of a DCI format 0 and may be transmitted as illustrated in the embodiment of Table 2.

The transmitted value of the CS (Cyclic Shift) field may be mapped as shown in Table 2 and n_{DMRS}⁽²⁾ for a first layer may be calculated in step S1440. That is, one of a total 8 values corresponding to 0, 6, 3, 4, 2, 8, 10, and 9 is calculated or determined from a CSI of 3 bits, as the CS value n_{DMRS,0}⁽²⁾ for the first layer. A number of layers of the user equipment, for example, whether a rank is 3, may be determined in step S1445. According to an embodiment of the present invention, a rank may correspond to 2, 3, and 4.

In a case where a rank is 1, the process is performed in the same manner as an existing LTE Rel-8 and thus, it is not included in embodiments of the present invention. However, the embodiments of the present invention may include a case in which a rank is 2, 3, and 4 in addition to a case in which a rank is 1. When the rank is 1, the process is performed in the same manner as the LTE Rel-8.

When the rank is different from 3, for example, when the rank corresponds to 2 or 4, a cyclic shift parameter value n_{DMRS,k}⁽²⁾ of another layer may be calculated by adding an offset to n_{DMRS,0}⁽²⁾ for a first layer by applying Equation 8 in step S1448. That is, when the number of layers is 2 or 4 (when a rank corresponds to 2 or 4), CS values for other layers may be allocated based on a CS allocation rule by applying 1) or 2) of Equation 8. Each of the CS values n_{DMRS,k}⁽²⁾ for other layers is given in a form of an offset Δₖ and the CS value n_{DMRS,0}⁽²⁾ for the first layer, based on a predetermined rule. For example, in a case where a rank is 2 since a total of 2 layers exist, when a CS value for a first layer is n_{DMRS,0}⁽²⁾, a CS value for a second layer is (n_{DMRS,0}⁽²⁾+6)mod 12 (In this example, the offset Δₖ is 0 when k=0, and the offset Δₖ is 6 when k=1). In a case where a total of 4 layers exist (the rank is 4), when a CS value for a first layer is n_{DMRS,0}⁽²⁾, a CS value for a second layer is (n_{DMRS,0}⁽²⁾+6)mod 12, a CS value for a third layer is (n_{DMRS,0}⁽²⁾+3)mod 12, and a CS value for a fourth layer is (n_{DMRS,0}⁽²⁾+9)mod 12 (in this example, the offset Δₖ is 0 when k=0, the offset Δₖ is 6 when k=1, the offset Δₖ is 3 when k=2, and the offset Δₖ is 9 when k=3), which has been described with reference to FIG. 11.

When the rank is 3 or 3 layers exist, an option 1 or an option 2 linked to the sequence and sequence group hopping method may be selected as illustrated in Table 14, which will be described in detail.

The user equipment determines a sequence and sequence group hopping scheme in step S1450. When the sequence and sequence group hopping scheme corresponds to a first sequence hopping method, the option 1 may be applied. For example, the option 1 of Equation 8 is applied to n_{DMRS,0}⁽²⁾ for a first layer, so as to calculate n_{DMRS,k}⁽²⁾ (k=1, 2) for a second layer and a third layer in step S1452. As described above, {0, 4, 8} or {0, 8, 4} may be applied as an offset.

When the sequence and sequence group hopping scheme corresponds to a second sequence hopping method, option 2 may be applied. That is, option 2 of Equation 3 may be applied to n_{DMRS,0}⁽²⁾ for a first layer, so as to calculate n_{DMRS,k}⁽²⁾ (k=1, 2) for a second layer and a third layer in step S1454. As described in the foregoing, one of {0, 6, 3}, {0, 3, 6}, {0, 9, 3}, {0, 9, 6}, {0, 9, 3}, {0, 3, 9} may be applied as an offset.

Hereinafter, n_{cs} and α may be calculated for each layer based on values calculated in steps S1420 through 1454, in step S1460. n_{DMRS}⁽¹⁾ and n_{PRS}(nₛ), which are parameters in n_{cs} to calculate a value of α, may vary based on each base station (cell and the like) and a slot time. However, the parameters may be constant in the same base station (cell and the like) and the same slot time. Therefore, a parameter that actually changes a value of n_{cs} is n_{DMRS}⁽²⁾. That is, the parameter that is scheduled for each UE in an upper stage and transmitted through a base station and the like is n_{DMRS}⁽²⁾ and α corresponding to the CS (Cyclic Shift) value of the UL DM-RS may be changed based on a value of n_{DMRS}⁽²⁾.

A DM-RS sequence may be generated based on the base sequence of step S1410 and α of step S1460 using Equation 1 in step S1470.

The DM-RS sequence generated based on Equations 1 and 2 may be mapped to a corresponding symbol of each slot, and mapping is performed by a resource element mapper in step S1480. When mapping is completed, an SC-FDMA symbol is generated, through an SC FDMA generator, from a Resource Element (RE) to which the DM-RS sequence is mapped, and a DM-RS signal is transmitted to a base station in step S1490.

In FIG. 14, a process that calculates a value of a cyclic shift parameter for each layer by adding a predetermined offset to a cyclic shift parameter n_{DMRS,0}⁽²⁾ of a first layer, based on a rank of a user equipment has been described. In particular, when a rank is 3, values of cyclic shift parameters of a second layer and a third layer may be calculated by adding an offset through applying option 1 or option 2 linked to a sequence and sequence group hopping scheme based on the sequence and sequence group hopping scheme. There are various schemes for a link between the sequence and sequence group hopping scheme and the options 1 and 2, which will be described in detail.

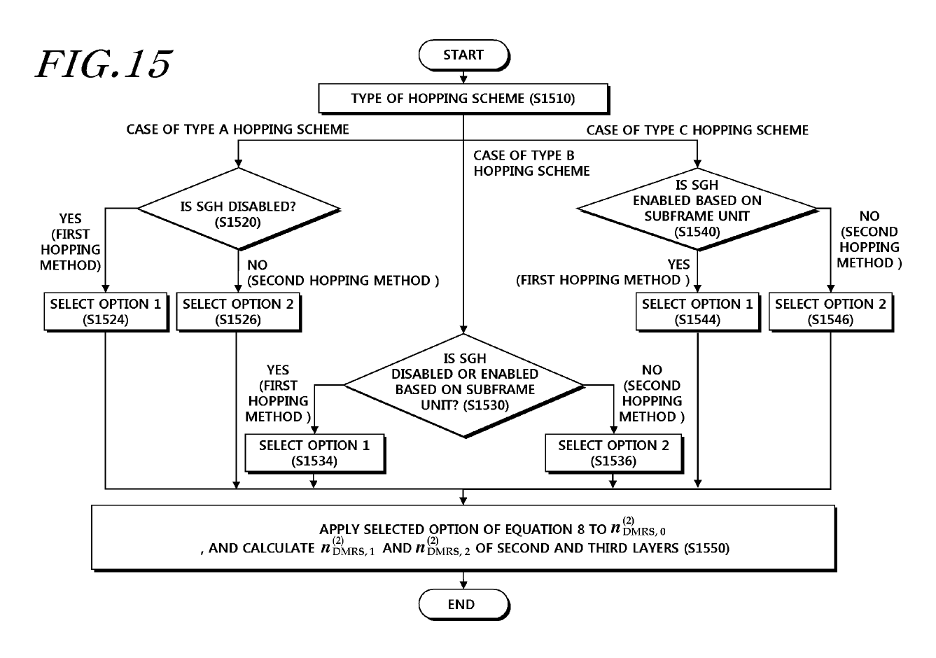

FIG. 15 is a diagram illustrating an example of selecting a CS allocation rule for each layer based on a type of a sequence and sequence group hopping scheme according to an embodiment of the present invention. In the embodiments of the present invention, one of the following three types of the sequence and sequence group hopping schemes may be selected and fixedly used. It should be construed that the sequence and sequence group hopping scheme is not selectively applied from among the following three types, but is fixedly selected from the three types based on communication standards or system specifications.

The three types of hopping methods S 1510 to which the embodiments of the present invention may be applied will be described in detail.

A type A corresponds to a case in which a sequence and sequence group hopping is classified into a disabled case and an enabled case. It may uniformly select whether to enable or disable the sequence and sequence group hopping with respect to all user equipments in a corresponding cell. Also, as described in the foregoing, it may disable a hopping with respect to a user equipment in a non-equal sized BW, and may enable the hopping with respect to other user equipments, in a UE-specific manner. In this example, the hopping in the type A corresponds to a slot-unit based hopping. Therefore, whether sequence and sequence group hopping are disabled is determined in step S1520. When both the sequence hopping and the sequence group hopping are disabled, it corresponds to a first hopping method and thus, an option 1 is selected in step S1524. It corresponds to increasing the size of a separation for each is layer of a user equipment, and the case corresponds to an MU-MIMO with non-equal sized BW. When at least one of the sequence hopping and the sequence group hopping is not disabled, option 2 is selected in step S1526. It corresponds to increasing a degree of a separation between user equipments, and may be applied to an MU-MIMO with equal sized BW.

In other words, when both the sequence hopping and the sequence group hopping are disabled in step S1520, a cyclic shift allocation rule that maximizes a distinction of each layer of the user equipment may be selected. When at least one of the sequence hopping and the sequence group hopping is enabled, a cyclic shift allocation rule that maximizes a distinction between the user equipment and other user equipments may be selected.

In this example, when the user equipment connects an MU-MIMO with non-equal sized BW, both the sequence hopping and the sequence group hopping of the user equipment are disabled, and at least one of the sequence hopping and the sequence group hopping is enabled based on a slot unit for other user equipments in the cell.

A type B corresponds to a first embodiment to set a sequence and sequence group hopping based on a subframe unit. A subframe unit-based hopping is enabled with respect to only a user equipment that uses an MU-MIMO with non-equal sized BW, and otherwise, a slot unit-based hopping is enabled. Two cases may be applicable in a case of disablement, and step S1530 of FIG. 15 links the disablement and enablement of a subframe unit-based hopping to the same option. It corresponds to adding a subframe unit-based hopping in a case of enablement when the sequence and sequence group hopping is set. A first hopping method disables both the sequence hopping and the sequence group hopping or enables both the sequence hopping and the sequence group hopping based on a subframe unit, and a second hopping method enables at least one of the sequence hopping and the sequence group hopping based on a slot unit. Therefore, whether the sequence and sequence group hopping is disabled or enabled based on a subframe unit is determined in step S1530. When both the sequence hopping and the sequence group hopping are disabled or enabled based on a subframe unit, this corresponds to the first hopping method and thus, an option 1 may be selected in step S1534. It corresponds to increasing a size of a separation for each layer in a user equipment, and the case corresponds to an MU-MIMO with non-equal sized BW. When at least one of the sequence hopping and the sequence group hopping is enabled based on a slot unit, an option 2 may be selected in step S1536. It corresponds to increasing a degree of a separation between user equipments, and may be applied to an MU-MIMO with equal sized BW.

In other words, when both the sequence hopping and the sequence group hopping are disabled or enabled based on a subframe unit in step S1530, a cyclic shift allocation rule that maximizes a distinction of each layer of the first user equipment may be selected. When at least one of the sequence hopping and the sequence group hopping is enabled based on a slot unit, a cyclic shift allocation rule that maximizes a distinction between the user equipment and other user equipments may be selected.

A type C corresponds to a second embodiment that sets a sequence and sequence group hopping based on a subframe unit. Like the type B, a subframe unit-based hopping is enabled with respect to only a user that uses an MU-MIMO with non-equal sized BW, and otherwise, a slot unit-based hopping is enabled. Two cases may be applied in a case of disablement, and step S1540 of FIG. 15 links the disablement and enablement of a slot unit-based hopping to the same option. It corresponds to adding a subframe unit-based hopping in a case of enablement when the sequence and sequence group hopping is set. A first hopping method enables both the sequence hopping and the sequence group hopping based on a subframe unit, and a second hopping method enables or disables at least one of the sequence hopping and the sequence group hopping based on a slot unit. Therefore, whether the sequence and sequence group hopping is enabled is determined based on a subframe unit in step S1540. When both the sequence hopping and the sequence group hopping are enabled based on a subframe unit, this corresponds to the first hopping method and thus, an option 1 may be selected in step S1544. It corresponds to increasing a size of a separation for each layer of a user equipment, and the case corresponds to an MU-MIMO with non-equal sized BW. When at least one of the sequence hopping and the sequence group hopping is disabled or enabled based on a slot unit, an option 2 may be selected in step S1546. It corresponds to increasing a degree of a separation between user equipments, and may be applied to an MU-MIMO with equal sized BW.

In other words, when both the sequence hopping and the sequence group hopping are enabled based on a subframe unit in step S1540, a cyclic shift allocation rule that maximizes a distinction of each layer of the user equipment may be selected. When at least one of the sequence hopping and the sequence group hopping is disabled or enabled based on a slot unit, a cyclic shift allocation rule that maximizes a distinction between the user equipment and other user equipments may be selected.

Cyclic shift parameters for a second layer and a third layer may be calculated by applying the option selected from steps S1524, S1526, S1534, S1536, S1544, and S1546 in step S1550.

In particular, in a case where the rank of the user equipment is 3 and respective layers correspond to a first, a second, and a third layers, when a first hopping method is used, an option 1 may be selected. According to an embodiment of the present invention, the cyclic shift allocation rule that maximizes a distinction of each layer of the first user equipment may calculate cyclic shift parameters to be applied to the second layer and the third layer by applying one of the offset sets {0, 4, 8} and {0, 8, 4} to the cyclic shift parameter determined for the first layer.

According to another embodiment, in a case where the rank of the user equipment is 3 and respective layers correspond to a first, a second, and a third layer, when a second hopping method is used, an option 2 may be selected. Also, the cyclic shift allocation rule that maximizes a distinction between the user equipment and other user equipments may calculate cyclic shift parameters to be applied to the second layer and the third layer by applying one of the offset sets {0, 6, 3}, {0, 3, 6}, {0, 6, 9}, {0, 9, 6}, {0, 9, 3}, and {0, 3, 9} to the cyclic shift parameter determined for the first layer.

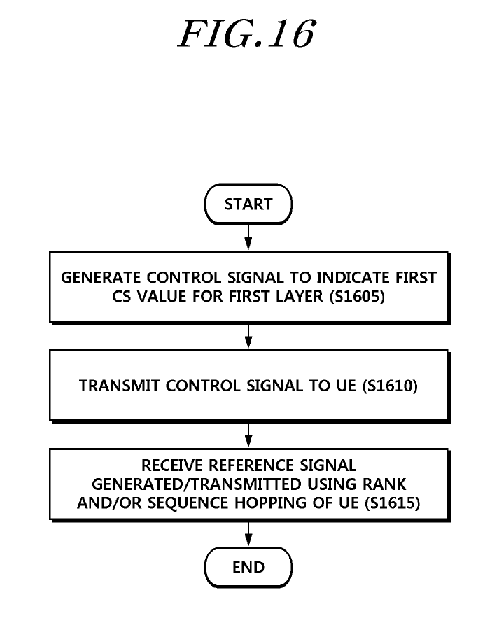

FIG. 16 is a diagram illustrating a process in which a base station receives a reference signal from a user equipment according to an embodiment of the present invention.

The base station generates, for the user equipment, a control signal to indicate a first cyclic shift value for a first layer in step S1605, and transmits the generated control signal to the corresponding user equipment in step S1610.

Subsequently, the base station receives the reference signal that the user equipment generates and transmits based on a rank of the user equipment and/or a sequence and sequence hopping scheme applied to the user equipment in step S1615.

The process in which the user equipment generates and transmits the reference signal based on the rank of the user equipment and/or the sequence and sequence hopping scheme of the user equipment in step S1615 will be described in detail.

The user equipment uses two or more layers, calculates the first cyclic shift parameter for the first layer from the control information received from the base station, determines the sequence and sequence group hopping method of the user equipment, selects a cyclic shift allocation rule linked to the determined sequence and sequence group hopping method, calculates a cyclic shift parameter to be applied to each layer using the selected allocation rule and the first cyclic shift parameter, and generates and transmits the reference signal using the cyclic shift parameter calculated for each layer.

Also, the user equipment calculates, from the control information received from the base station, the first cyclic shift parameter for the first layer from among two or more layers. When a rank of the first user is 3 and a sequence and sequence group hopping method of the first user equipment is a first hopping method, a cyclic shift allocation rule that maximizes a distinction of each layer of the first user equipment may be selected. When the rank of the first user equipment is 3 and the sequence and sequence group hopping method of the first user equipment is a second hopping method, a cyclic shift allocation rule that maximizes a distinction between the first user equipment and other user equipments may be selected. Subsequently, cyclic shift parameters to be applied to remaining layers excluding the first layer may be calculated using the selected cyclic shift allocation rule, and a reference signal may be generated using the cyclic shift parameter for each layer and may be transmitted.

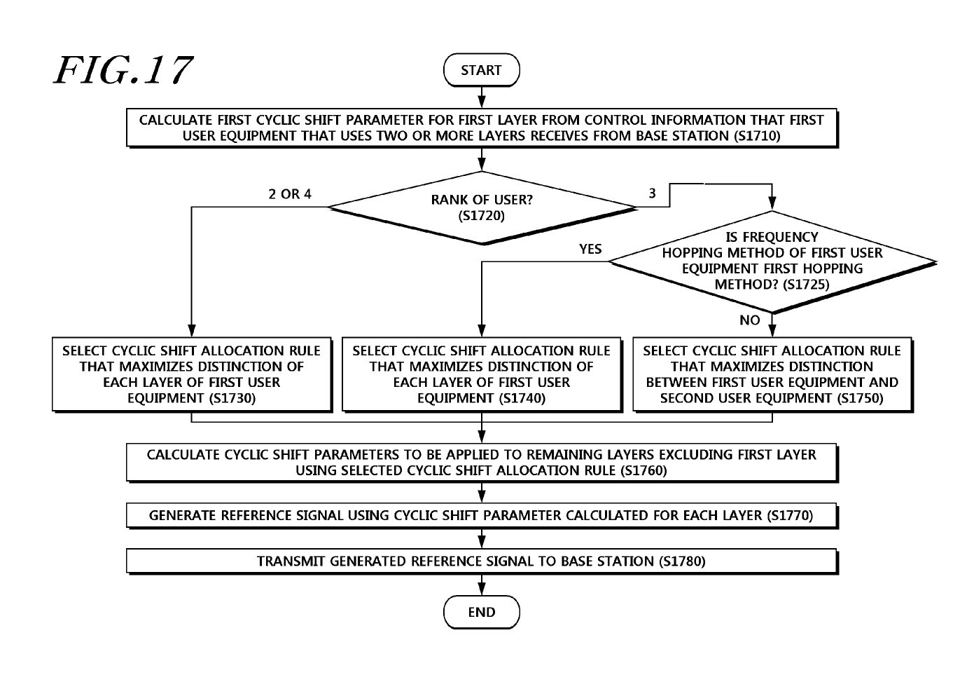

FIG. 17 is a diagram illustrating a process in which a user equipment receives a cyclic shift parameter for a first layer from a base station, and generates a reference signal by selecting a cyclic shift allocation rule that enables calculation of cyclic shift parameters to be applied to other layers according to an embodiment of the present invention. In this process, a cyclic shift allocation rule that is linked to a sequence and sequence group hopping method may be selected.

A first user equipment that uses two or more layers calculates a first cyclic shift parameter for a first layer from control information received from the base station in step S1710. In step S1720, a rank of the first user equipment is determined. When the rank of the first user equipment is 2 or 4, a cyclic shift allocation rule that maximizes a distinction of each layer of the first user equipment is selected in step S1730. When the rank of the first user equipment is 3, a cyclic shift allocation rule linked to a sequence and sequence group hopping method is selected as described in the foregoing, which will be described in detail.

When the sequence and sequence group hopping method of the user equipment is the first hopping method, a cyclic shift allocation rule that maximizes a distinction of each layer of the first user equipment is selected in step S 17 When the sequence and sequence group hopping method of the user equipment is the second hopping method, a cyclic shift allocation rule that maximizes a distinction between the user equipment and other user equipments is selected in step S 1750.

As described in the foregoing, an embodiment of the first hopping method may correspond to a subframe unit-based enabling method, and an embodiment of the second hopping method may correspond to a slot unit-based enabling method. In the case of disablement, an option 1 or an option 2 may be selected based on standards used in a communication system.

Cyclic shift parameters to be applied to remaining layers excluding the first layer may be calculated using the selected cyclic shift allocation rule i1p S1760. A reference is signal is generated using the cyclic shift parameter of each layer i1p S1770. Subsequently, the generated reference signal is transmitted to the base station iep S1780.

Option 1 and option 2 will be described as follows. In a case where the rank of the user equipment is 3 and respective layers are first, second, and third layers, when the first hopping method is used, option 1 may be selected. The option 1 indicates a cyclic shift allocation rule that maximizes a distinction of each layer of the user equipment. In step S1760, cyclic shift parameters to be applied to the second layer and the third layer may be calculated by applying one of the offset sets {0, 4, 8}, and {0, 8, 4} to the determined cyclic shift parameter for the first layer.

In a case where the rank of the user equipment is 3 and respective layers are first, second, and third layers, when the second hopping method is used, the option 2 may be selected. The option 2 indicates a cyclic shift allocation rule that maximizes a distinction between the user equipment and other user equipments. In step S1760, cyclic shift parameters to be applied to the second layer and the third layer may be calculated by applying one of the offset s {0, 6, 3}, {0, 3, 6}, {0, 6, 9}, {0, 9, 6}, {0, 9, 3}, {0, 3, 9} to the determined cyclic shift parameter for the first layer.

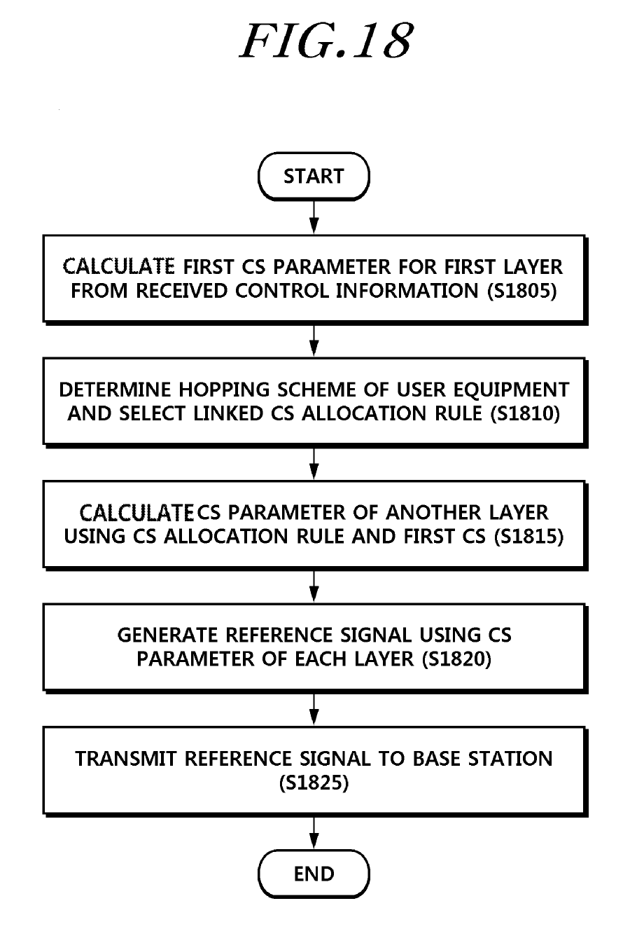

FIG. 18 is a diagram illustrating a process in which a user equipment receives a cyclic shift parameter for a first layer from a base station, and generates a reference signal by selecting a cyclic shift allocation rule that enables calculation of cyclic shift parameters to be is applied to other layers according to another embodiment of the present invention.

First, a user equipment that uses two or more layers calculates a first cyclic shift parameter for a first layer from control information received from a base station in step S1805. A sequence and sequence group hopping method of the first user equipment is determined, and a cyclic shift allocation rule linked to a frequency hopping method is selected in step S1810.

Step S1810 will be described in detail. As described in FIG. 15, when the sequence and sequence group hopping corresponds to one of the types A, B, and C based on communication standards or communication system specifications, a cyclic shift allocation rule appropriate for the corresponding type is selected. This is similar to the descriptions of FIG. 15 and thus, detailed descriptions thereof will be omitted to avoid redundant descriptions.

Subsequently, the user equipment calculates a cyclic shift parameter to be applied to each layer (a second layer, a third layer, and the like) using the selected cyclic shift allocation rule and the first cyclic shift parameter in step S1815.

Subsequently, a reference signal is generated using the cyclic shift parameter calculated for each layer in step S1820, and the generated reference signal is transmitted to the base station (eNB) in step S1825.

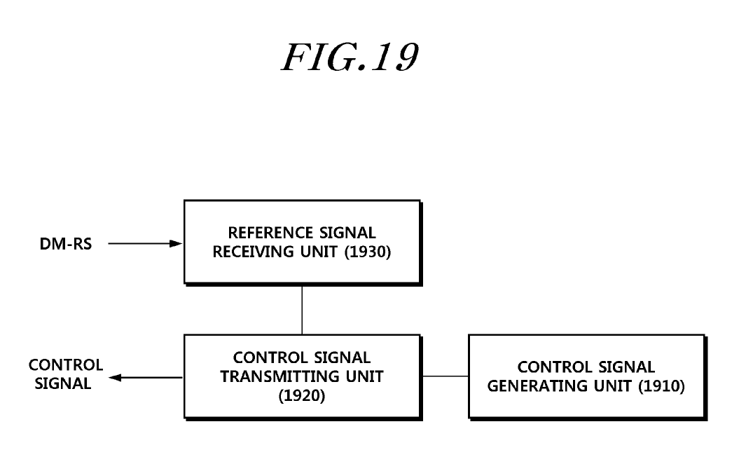

FIG. 19 is a diagram illustrating a configuration of an apparatus for receiving a reference signal generated/transmitted using a sequence and sequence hopping scheme in an MIMO environment according to an embodiment of the present invention. The configuration of FIG. 19 may correspond to a base station and a device coupled with the base station.

The overall configuration of the reference signal receiving apparatus may be configured to include a control signal generating unit 1910, a control signal transmitting unit 1920, and a reference signal receiving unit 1930 to receive a reference signal generated/transmitted using a sequence hopping scheme.

The control signal generating unit 1910 generates, for a user equipment that uses two or more layers, a control signal to indicate a first cyclic shift value for a first layer.

The control signal transmitting unit 1920 transmits the control signal generated by the control signal generating unit 1910 to the corresponding user equipment.

The reference signal receiving unit 1930 receives the reference signal that the user equipment generates and transmits based on a rank of the user equipment and/or a sequence and sequence hopping scheme of the user equipment according to FIGS. 15 and 17.

A process in which the user equipment generates the reference signal based on the rank of the user equipment and/or the sequence and sequence hopping scheme will be described in detail.

The user equipment uses two or more layers, calculates a first cyclic shift parameter for the first layer from control information received from the base station, determines a sequence and sequence group hopping method of the user equipment, selects a cyclic shift allocation rule linked to the determined sequence and sequence group hopping method, calculates a cyclic shift parameter to be applied to each layer using the selected allocation rule and the first cyclic shift parameter, and generates and transmits the reference signal using the cyclic shift parameter calculated for each layer.

Also, the user equipment calculates, from the control information received from the base station, the first cyclic shift parameter for the first layer from among two or more layers, selects a cyclic shift allocation rule that maximizes a distinction of each layer of the first user equipment when a rank of the first user equipment is 3 and a sequence and sequence group hopping method of the first user is a first hopping method, and selects a cyclic shift allocation rule that maximizes a distinction between the first user equipment and other user equipments when the rank of the first user equipment is 3 and the sequence and sequence group hopping method of the first user equipment is a second hopping method. Subsequently, cyclic shift parameters to be applied to remaining layers excluding the first layer are calculated using the selected cyclic shift allocation rule, and a reference signal is generated using the cyclic shift parameter calculated for each layer and is transmitted.

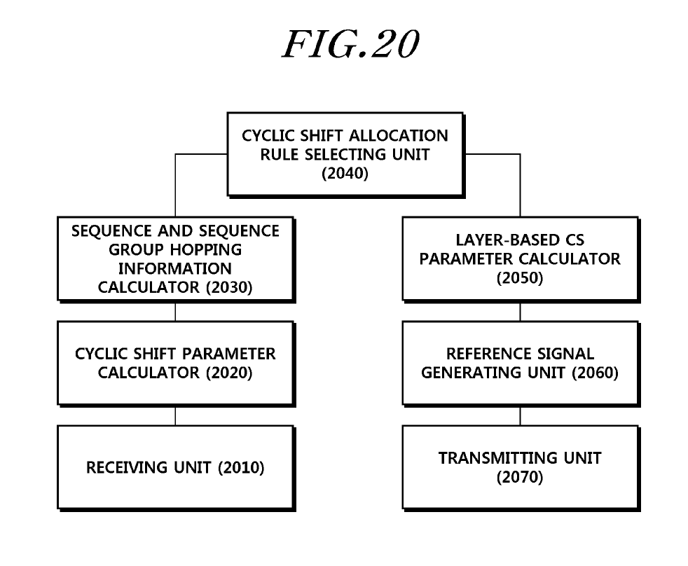

FIG. 20 is a diagram illustrating a configuration of an apparatus for transmitting a reference signal using sequence and sequence group hopping information in an MIMO environment according to an embodiment of the present invention. The configuration of FIG. 20 may correspond to a user equipment and a device coupled with the user equipment. Referring to FIGS. 14, 15, and 17, the function or configuration of the apparatus of FIG. 20 may is be determined, which will be described in detail.

The apparatus of FIG. 20 includes a receiving unit 2010, a cyclic shift parameter calculator 2020, a sequence and sequence group hopping information calculator 2030, a cyclic shift allocation rule selecting unit 2040, a layer-based cyclic shift parameter calculator 2050, a reference signal generating unit 2060, and a transmitting unit 2070. The user equipment that uses two or more layers receives, through the receiving unit 2010, control information from a base station. An embodiment of the control information is 3-bit information in a Cyclic Shift field in a DCI format 0.

The cyclic shift parameter calculator 2020 calculates a first cyclic shift parameter for a first layer from the control information received by the receiving unit 2010. The sequence and sequence group hopping information calculator 2030 calculates information associated with the sequence and sequence group hopping method.

According to an embodiment of the present invention, the cyclic shift allocation rule selecting unit 2040 selects a cyclic shift allocation rule that maximizes a distinction of each layer of a first user equipment when a rank of the first user equipment is 2 or 4, selects a cyclic shift allocation rule that maximizes a distinction of each layer of the first user equipment when the rank of the first user equipment is 3 and a sequence and sequence group hopping method of the user equipment is a first hopping method, and selects a cyclic shift allocation rule that maximizes a distinction between the user equipment and other user equipments when the rank of the first user equipment is 3 and the sequence and sequence group hopping method of the user equipment is a second hopping method.

The layer-based cyclic shift parameter calculator 2050 calculates cyclic shift parameters to be applied to remaining layer excluding the first layer using the selected cyclic shift allocation rule.

The reference signal generating unit 2060 generates a reference signal using the cyclic shift parameter generated for each layer, and the transmitting unit 2070 transmits the generated reference signal to the base station.

Here, an embodiment of the first hopping method is a subframe unit-based enabling method, and an embodiment of the second hopping method is a slot unit-based enabling method.

According to another embodiment of the present invention, the apparatus of FIG. 20 may be configured as follows.

A user equipment that uses two or more layers receives, through the receiving unit 2010, control information from a base station. An embodiment of the control information is 3-bit information in a Cyclic Shift field in a DCI format 0.

The cyclic shift parameter calculator 2020 calculates a first cyclic shift parameter for a first layer from the control information received by the receiving unit 2010.

The frequency hopping information calculator 2030 calculates information is associated with a frequency hopping method.

According to an embodiment of the present invention, the cyclic shift allocation rule selecting unit 2040 selects a cyclic shift allocation rule linked to the frequency hopping method determined by the frequency hopping information calculator 2030.

The layer-based cyclic shift parameter calculator 2050 calculates a cyclic shift parameter to be applied to each layer using the selected allocation rule and the first cyclic shift parameter.

The reference signal generating unit 2060 generates a reference signal using the cyclic shift parameter generated for each layer, and the transmitting unit 2070 transmits the generated reference signal to the base station.

Here, the first hopping method and the second hopping method may vary based on standards used in the communication system. The first hopping method and the second hopping method are distinguished based on each type as described with reference to FIG. 9, and a base station may determine a cyclic shift parameter based on a cyclic shift allocation rule linked to each hopping method.

When the rank of the user equipment is 3 and respective layers are first, second, and third layers, the cyclic shift allocation rule selecting unit 2030 and the layer-based cyclic shift parameter calculator 2050 may apply a cyclic shift allocation rule that maximizes a distinction of each layer of the user equipment, and may determine cyclic shift parameters to be applied to the second layer and the third layer by applying one of the offset sets {0, 4, 8} and {0, 8, 4} to a cyclic shift parameter determined for the first layer. This is an allocation rule linked to the first hopping method. Also, a cyclic shift allocation rule that maximizes a distinction between the user equipment and other user equipments may be applied, and cyclic shift parameters to be applied to the second layer and the third layer may be determined by applying one of the offset sets {0, 6, 3}, {0, 3, 6}, {0, 6, 9}, {0, 9, 6}, {0, 9 3}, and {0, 3, 9} to the cyclic shift parameter determined for the first layer. This is a rule linked to the second hopping method.

According to an embodiment of the present invention, without an additional signaling, a predetermined rule for allocating a CS value to another layer is appropriately selected and used. That is, a user equipment may not merely use one of two CS allocation methods (options 1 and 2), and may recognize which one of two CS allocation methods is appropriate for the given condition without any additional signaling. This may comply with the intention of generating a predetermined rule for allocating a CS value to another layer to exclude the additional signaling. Also, to appropriately select and use a predetermined rule, the additional signaling is not provided and an amount of information transmitted and received may not be increased.

According to an embodiment of the present invention, a method and apparatus for allocating a Cyclic Shift (CS) value of each layer of an Uplink (UL) Demodulation Reference Signal (DM-RS) is provided. The method and apparatus may determine a Cyclic Shift (CS) value of a first layer from a CSI (Cyclic Shift Indication) value transmitted from a base station, and may allocate a Cyclic Shift (CS) value of another layer based on the value and a cyclic shift allocation rule that may be differently selected based on an SGH (Sequence/Sequence Group hopping) of a UL DM-RS transferred from the base station, without an additional signaling.

Although a preferred embodiment of the present invention has been described for illustrative purposes, those skilled in the art will appreciate that various modifications, additions and substitutions are possible, without departing from the scope and spirit of the invention as disclosed in the accompanying claims. Therefore, the embodiments disclosed in the present invention are intended to illustrate the scope of the technical idea of the present invention, and the scope of the present invention is not limited by the embodiment. The scope of the present invention shall be construed on the basis of the accompanying claims in such a manner that all of the technical ideas included within the scope equivalent to the claims belong to the present invention.

1. A method of receiving control information and generating a reference signal based on an MIMO operation mode, the method comprising:
receiving, by a user equipment, a cyclic shift parameter from a base station; and
setting a cyclic shift value and an OCC value of each layer using a cyclic shift and orthogonality allocation rule selected by referring to a parameter that is associated with the MIIVIO operation mode of the user equipment and is transferred from an upper layer and the received cyclic shift parameter, and generating a reference signal using the set values and transmitting the reference signal.

2. The method as claimed in claim 1, wherein a first allocation rule or a second allocation rule is selected based on the parameter transferred from the upper layer,
wherein each the first allocation rule and the second rule selects a different one from Tables (A) and (B):
TABLE (A)

| | CS | | | | OCC | | | |
|---|---|---|---|---|---|---|---|---|
| CS field value | First | Second | Third | Fourth | First | Second | Third | Fourth |
| in uplink related | layer | layer | layer | layer | layer | layer | layer | layer |
| DCI format | (Layer 0) | (Layer 1) | (Layer 2) | (Layer 3) | (Layer 0) | (Layer 1) | (Layer 2) | (Layer 3) |
| 000 | 0 | 3 | 6 | 9 | 0 | 1 | 0 | 1 |
| 001 | 6 | 9 | 0 | 3 | 1 | 0 | 1 | 0 |
| 010 | 3 | 6 | 9 | 0 | 1 | 0 | 1 | 0 |
| 011 | 4 | 7 | 10 | 1 | 0 | 1 | 0 | 1 |
| 100 | 2 | 5 | 8 | 11 | 0 | 1 | 0 | 1 |
| 101 | 8 | 11 | 2 | 5 | 1 | 0 | 1 | 0 |
| 110 | 10 | 1 | 4 | 7 | 1 | 0 | 1 | 0 |
| 111 | 9 | 0 | 3 | 6 | 0 | 1 | 0 | 1 |

and
TABLE (B)

| | CS | | | | OCC | | | |
|---|---|---|---|---|---|---|---|---|
| CS field value | First | Second | Third | Fourth | First | Second | Third | Fourth |
| in uplink related | layer | layer | layer | layer | layer | layer | layer | layer |
| DCI format | (Layer 0) | (Layer 1) | (Layer 2) | (Layer 3) | (Layer 0) | (Layer 1) | (Layer 2) | (Layer 3) |
| 000 | 0 | 3 | 6 | 9 | 0 | 0 | 0 | 0 |
| 001 | 6 | 9 | 0 | 3 | 1 | 1 | 1 | 1 |
| 010 | 3 | 6 | 9 | 0 | 1 | 1 | 1 | 1 |
| 011 | 4 | 7 | 10 | 1 | 0 | 0 | 0 | 0 |
| 100 | 2 | 5 | 8 | 11 | 0 | 0 | 0 | 0 |
| 101 | 8 | 11 | 2 | 5 | 1 | 1 | 1 | 1 |
| 110 | 10 | 1 | 4 | 7 | 1 | 1 | 1 | 1 |
| 111 | 9 | 0 | 3 | 6 | 0 | 0 | 0 | 0 |

or selects a different one from Tables (C) and (D):
TABLE (C)

| | CS | | | | OCC | | | |
|---|---|---|---|---|---|---|---|---|
| CS field value | First | Second | Third | Fourth | First | Second | Third | Fourth |
| in uplink related | layer | layer | layer | layer | layer | layer | layer | layer |
| DCI format | (Layer 0) | (Layer 1) | (Layer 2) | (Layer 3) | (Layer 0) | (Layer 1) | (Layer 2) | (Layer 3) |
| 000 | 0 | 6 | 3 | 9 | 0 | 0 | 1 | 1 |
| 001 | 6 | 0 | 9 | 3 | 1 | 1 | 0 | 0 |
| 010 | 3 | 9 | 6 | 0 | 1 | 1 | 0 | 0 |
| 011 | 4 | 10 | 7 | 1 | 0 | 0 | 0 | 0 |
| 100 | 2 | 8 | 5 | 11 | 0 | 0 | 0 | 0 |
| 101 | 8 | 2 | 11 | 5 | 1 | 1 | 1 | 1 |
| 110 | 10 | 4 | 1 | 7 | 1 | 1 | 1 | 1 |
| 111 | 9 | 3 | 0 | 6 | 0 | 0 | 1 | 1 |

and
TABLE( D)

| | CS | | | | OCC | | | |
|---|---|---|---|---|---|---|---|---|
| CS field value | First | Second | Third | Fourth | First | Second | Third | Fourth |
| in uplink related | layer | layer | layer | layer | layer | layer | layer | layer |
| DCI format | (Layer 0) | (Layer 1) | (Layer 2) | (Layer 3) | (Layer 0) | (Layer 1) | (Layer 2) | (Layer 3) |
| 000 | 0 | 3 | 6 | 9 | 0 | 1 | 0 | 1 |
| 001 | 6 | 9 | 0 | 3 | 1 | 0 | 1 | 0 |
| 010 | 3 | 6 | 9 | 0 | 1 | 0 | 1 | 0 |
| 011 | 4 | 7 | 10 | 1 | 0 | 0 | 0 | 0 |
| 100 | 2 | 5 | 8 | 11 | 0 | 0 | 0 | 0 |
| 101 | 8 | 11 | 2 | 5 | 1 | 1 | 1 | 1 |
| 110 | 10 | 1 | 4 | 7 | 1 | 1 | 1 | 1 |
| 111 | 9 | 0 | 3 | 6 | 0 | 1 | 0 | 1 |

3. The method as claimed in claim 1, wherein the parameter transferred from the upper layer corresponds to an indication value of a UE-specific SGH (sequence and sequence group hopping);
the selected allocation rule corresponds to Table 6 when the indication value of the UE-specific SGH is enabled; and
the selected allocation rule corresponds to Table 7 when the indication value of the UE-specific SGH is disabled.

4. The method as claimed in claim 1, wherein, when the MIMO operation mode of the user equipment corresponds to an SU-MIMO, the selected orthogonality allocation rule includes that OCC values of a first layer and a second layer are different from each other, OCC values of a third layer and a fourth layer are different from each other, and OCC values of the first layer and the third layer are identical.

5. The method as claimed in claim 1, wherein, when the MIMO operation mode of the user equipment corresponds to an SU-MIMO or corresponds to an MU-MIMO of which a rank is 1 or 2, the selected orthogonality allocation rule includes that OCC values of a first layer and a second layer are identical, OCC values of a third layer and a fourth layer are identical, and OCC values of the first layer and the third layer are different from each other.

6. The method as claimed in claim 1, wherein, when the MIMO operation mode of the user equipment corresponds to an MU-MIMO, the selected orthogonality allocation rule includes that OCC values of all layers are identical.

7. A method of transmitting control information based on an MIMO operation mode, the method comprising:
selecting a cyclic shift and orthogonality allocation rule by referring to a parameter that a base station transfers to a user equipment in an upper layer with respect to an MIMO operation mode of the user equipment; and
transmitting, to the user equipment, a cyclic shift parameter determined based on the selected allocation rule.

8. The method as claimed in claim 7, wherein a first allocation rule or a second allocation rule is selected based on the parameter value,
wherein each the first allocation rule and the second rule selects a different one from Tables (A) and (B):
TABLE (A)

| | CS | | | | OCC | | | |
|---|---|---|---|---|---|---|---|---|
| CS field value | First | Second | Third | Fourth | First | Second | Third | Fourth |
| in uplink related | layer | layer | layer | layer | layer | layer | layer | layer |
| DCI format | (Layer 0) | (Layer 1) | (Layer 2) | (Layer 3) | (Layer 0) | (Layer 1) | (Layer 2) | (Layer 3) |
| 000 | 0 | 3 | 6 | 9 | 0 | 1 | 0 | 1 |
| 001 | 6 | 9 | 0 | 3 | 1 | 0 | 1 | 0 |
| 010 | 3 | 6 | 9 | 0 | 1 | 0 | 1 | 0 |
| 011 | 4 | 7 | 10 | 1 | 0 | 1 | 0 | 1 |
| 100 | 2 | 5 | 8 | 11 | 0 | 1 | 0 | 1 |
| 101 | 8 | 11 | 2 | 5 | 1 | 0 | 1 | 0 |
| 110 | 10 | 1 | 4 | 7 | 1 | 0 | 1 | 0 |
| 111 | 9 | 0 | 3 | 6 | 0 | 1 | 0 | 1 |

and
TABLE (B)

| | CS | | | | OCC | | | |
|---|---|---|---|---|---|---|---|---|
| CS field value | First | Second | Third | Fourth | First | Second | Third | Fourth |
| in uplink related | layer | layer | layer | layer | layer | layer | layer | layer |
| DCI format | (Layer 0) | (Layer 1) | (Layer 2) | (Layer 3) | (Layer 0) | (Layer 1) | (Layer 2) | (Layer 3) |
| 000 | 0 | 3 | 6 | 9 | 0 | 0 | 0 | 0 |
| 001 | 6 | 9 | 0 | 3 | 1 | 1 | 1 | 1 |
| 010 | 3 | 6 | 9 | 0 | 1 | 1 | 1 | 1 |
| 011 | 4 | 7 | 10 | 1 | 0 | 0 | 0 | 0 |
| 100 | 2 | 5 | 8 | 11 | 0 | 0 | 0 | 0 |
| 101 | 8 | 11 | 2 | 5 | 1 | 1 | 1 | 1 |
| 110 | 10 | 1 | 4 | 7 | 1 | 1 | 1 | 1 |
| 111 | 9 | 0 | 3 | 6 | 0 | 0 | 0 | 0 |

or selects a different one from Tables (C) and (D):
TABLE (C)

| | CS | | | | OCC | | | |
|---|---|---|---|---|---|---|---|---|
| CS field value | First | Second | Third | Fourth | First | Second | Third | Fourth |
| in uplink related | layer | layer | layer | layer | layer | layer | layer | layer |
| DCI format | (Layer 0) | (Layer 1) | (Layer 2) | (Layer 3) | (Layer 0) | (Layer 1) | (Layer 2) | (Layer 3) |
| 000 | 0 | 6 | 3 | 9 | 0 | 0 | 1 | 1 |
| 001 | 6 | 0 | 9 | 3 | 1 | 1 | 0 | 0 |
| 010 | 3 | 9 | 6 | 0 | 1 | 1 | 0 | 0 |
| 011 | 4 | 10 | 7 | 1 | 0 | 0 | 0 | 0 |
| 100 | 2 | 8 | 5 | 11 | 0 | 0 | 0 | 0 |
| 101 | 8 | 2 | 11 | 5 | 1 | 1 | 1 | 1 |
| 110 | 10 | 4 | 1 | 7 | 1 | 1 | 1 | 1 |
| 111 | 9 | 3 | 0 | 6 | 0 | 0 | 1 | 1 |

and
TABLE (D)

| | CS | | | | OCC | | | |
|---|---|---|---|---|---|---|---|---|
| CS field value | First | Second | Third | Fourth | First | Second | Third | Fourth |
| in uplink related | layer | layer | layer | layer | layer | layer | layer | layer |
| DCI format | (Layer 0) | (Layer 1) | (Layer 2) | (Layer 3) | (Layer 0) | (Layer 1) | (Layer 2) | (Layer 3) |
| 000 | 0 | 3 | 6 | 9 | 0 | 1 | 0 | 1 |
| 001 | 6 | 9 | 0 | 3 | 1 | 0 | 1 | 0 |
| 010 | 3 | 6 | 9 | 0 | 1 | 0 | 1 | 0 |
| 011 | 4 | 7 | 10 | 1 | 0 | 0 | 0 | 0 |
| 100 | 2 | 5 | 8 | 11 | 0 | 0 | 0 | 0 |
| 101 | 8 | 11 | 2 | 5 | 1 | 1 | 1 | 1 |
| 110 | 10 | 1 | 4 | 7 | 1 | 1 | 1 | 1 |
| 111 | 9 | 0 | 3 | 6 | 0 | 1 | 0 | 1 |

9. The method as claimed in claim 7, wherein the transferred parameter corresponds to an indication value of a UE-specific SGH (sequence and sequence group hopping);
the selected allocation rule corresponds to Table 6 when the indication value of the UE-specific SGH is enabled; and
the selected allocation rule corresponds to Table 7 when the indication value of the UE-specific SGH is disabled.

10. The method as claimed in claim 7, wherein, when the MIMO operation mode of the user equipment corresponds to an SU-MIMO, the selected orthogonality allocation rule includes that OCC values of a first layer and a second layer are different from each other, OCC values of a third layer and a fourth layer are different from each other, and OCC values of the first layer and the third layer are identical.

11. The method as claimed in claim 7, wherein, when the MIMO operation mode of the user equipment corresponds to an SU-MIMO or corresponds to an MU-MIMO of which a rank is 1 or 2, the selected orthogonality allocation rule includes that OCC values of a first layer and a second layer are identical, OCC values of a third layer and a fourth layer are identical, and OCC values of the first layer and the third layer are different from each other.

12. The method as claimed in claim 7, wherein, when the MIMO operation mode of the user equipment corresponds to an MU-MIMO, the selected orthogonality allocation rule includes that OCC values of all layers are identical.

13. An apparatus for receiving control information and generating a reference signal based on an MIMO operation mode, the apparatus comprising:
a receiving unit to receive, in a user equipment, control information from a base station;
a cyclic shift parameter calculator to calculate a cyclic shift parameter from a control signal received by the receiving unit;
a cyclic shift and orthogonality allocation rule selecting unit to select a cyclic shift and orthogonality allocation rule by referring to a parameter that is associated with the MIMO operation mode of the user equipment and is transferred from an upper layer and the cyclic shift parameter;
a reference signal generating unit to set a cyclic shift value and an OCC value for each layer using the selected allocation rule and the received cyclic shift parameter, and to generate a reference signal using the set values; and
a transmitting unit to transmit the generated reference signal to the base station.

14. An apparatus for transmitting control information, the apparatus comprising:
a user equipment configuration status determining unit to determine an MIMO environment of a user equipment;
a cyclic shift and orthogonality allocation rule selecting unit to select a cyclic shift and rthogonality allocation rule appropriate for the determined MIMO environment by referring to a parameter that a base station transfers to the user equipment in an upper layer with respect to the MIMO environment;
a signal generating unit to generate a signal to transmit control information including a cyclic shift parameter determined based on the selected allocation rule to the user equipment; and
a transceiving unit to transmit the signal to the user equipment.
